(19) United States
(12) Patent Application Publication
(10) Pub. No.: US 2025/0115007 A1
(43) Pub. Date: Apr. 10, 2025

(54) PIPE FUSION APPARATUS AND METHOD, AND INDEXER, STRIPPER, BRAKE, AND HEATER RETENTION MECHANISM THEREFOR

(71) Applicant: MCELROY MANUFACTURING, INC., Tulsa, OK (US)

(72) Inventors: Tyler V. King, Tulsa, OK (US); Paul John Donaldson, Broken Arrow, OK (US); Seth P. Ahrens, Tulsa, OK (US)

(21) Appl. No.: 18/910,115

(22) Filed: Oct. 9, 2024

Related U.S. Application Data
(60) Provisional application No. 63/588,818, filed on Oct. 9, 2023.
(60) Provisional application No. 63/631,708, filed on Apr. 9, 2024.

(51) Int. Cl. B29C 65/00; B29C 65/02

(52) U.S. Cl. CPC B29C 66/5221; B29C 65/02; B29K 2023/06

(57) ABSTRACT

A pipe fusion apparatus and method which (a) provide an indexer carriage for the facer and heater and a brake which automatically holds the indexer at predetermined locations, (b) operate to automatically strip the heater from the molten ends of the pipe, (c) also operate to automatically return the heater to its retracted position, and (d) provide a heater retention mechanism for holding the heater at desired downward intermediate positions, so that the operator will have both hands free for cleaning or taking temperature readings, without interfering with the subsequent return of the heater from the fusion zone to the fully retracted position of the heater.

### RELATED CASES

This application claims the benefit of both U.S. Provisional Patent Application No. 63/588,818 filed Oct. 9, 2023 and U.S. Provisional Patent Application No. 63/631,708 filed Apr. 9, 2024, and incorporates each of these provisional applications herein by reference in its entirety as if fully set forth at this point

### FIELD OF THE INVENTION

The present invention relates to apparatuses and methods for fusing the ends of pipe sections together, and to indexer assemblies, heater stripping systems, and heater intermediate retention mechanisms for use in such apparatuses and methods.

### BACKGROUND OF THE INVENTION

Butt fusion machines and process are used for permanently joining together lengths of pipe formed of polyethylene or other thermoplastic materials. The fusion process for joining the ends of two pipe sections typically comprises the steps of: (1) using a facer to plane the adjacent ends of the two pipe sections so that they are square and parallel to each other; (2) heating the adjacent ends of the pipe sections to a prescribed fusion temperature for a period of time; (3) pressing the molten ends of the pipe sections together at a prescribed pressure for a predetermined time to bond the ends of the pipe sections together, and then (4) allowing the fused joint to cool for a prescribed amount of time before releasing the applied pressure.

A pipe fusion machine for performing the butt fusion process will typically comprise: (a) one or more fixed jaws (i.e., one or more, preferably a pair, of pipe clamps) which are mounted in fixed position on a frame or platform for releasably holding a first section of pipe; (b) one or more movable jaws (i.e., one or more, preferably a pair, of pipe clamps) for holding a second section of pipe and moving the end of the second section of pipe toward and away from the first section of pipe; (c) a carriage on which the movable jaws are mounted for carrying the movable jaws longitudinally toward and away from the fixed jaws; (d) a facer which is removably positionable in the fusion zone of the apparatus for removing material from the adjacent ends of the two pipes so that they are square and parallel; and (e) a heater which is also removably positionable in the fusion zone for heating the ends of the pipe sections to a molten state for the fusion process.

Although other power systems can alternatively be used for at least some applications, the pipe fusion apparatus will typically include a hydraulic power system which provides the force necessary for pressing the molten ends of the pipe sections together during the fusion process.

In addition, the pipe fusion machine can be a self-propelled apparatus, which includes wheels or tracks that are driven by a motor or engine, or can be mounted on a trailer or other non-powered vehicle which is pulled or carried to the fusion site.

The facer and the heater can be pivoting structures that may be swung or rotated into position between the adjacent ends of the pipe sections and then rotated out of the way when not in use. The facer will typically include three or four blades on each side thereof for truing or “facing” the ends of the pipe sections. The heater will typically comprise electric heating elements disposed between two circular heating plates which are simultaneously contacted by the opposing ends of the pipe sections.

Industry and governmental standards are in place throughout the world which dictate how quickly the molten ends of the pipe sections must be pressed into contact with each other after the heater is separated from the ends of the pipe sections and removed from the fusion zone. In addition, the fusion standards in some jurisdictions require that the heater must be automatically removed from fusion zone at the end of the heating operation.

In this regard, a need exists for an improved apparatus, system, and method for automatically stripping the molten ends of the pipe sections from the opposite sides of the heater at the completion of the heating operation and then automatically removing the heater from the fusion zone.

The improved apparatus, system, and method will preferably (a) be readily adaptable for installation and use, at reduced cost, on fusion machines of all sizes, including fusion machines for smaller pipes, (b) be less complex than, and provide a level of reliability and repeatability that equals or exceeds the reliability and repeatability of, prior automated systems, (c) replicate a fully automated electronically controlled system with a mechanical system, (d) provide braking to hold an indexer in any predetermined location to help with operator efficiency and reduce operator fatigue, and maintain position when working on a grade, (e) not require that the ends of the pipe sections be faced to the stops, and (f) allow all components to be more easily accessed for maintenance or replacement.

### SUMMARY OF THE INVENTION

The present invention resolves the problems and satisfies the needs mentioned above.

In one aspect, there is provided a pipe fusion apparatus for fusing the ends of two pipe sections together. The apparatus preferably comprises: (i) one or more fixed pipe jaws; (ii) one or more movable pipe jaws which is/are longitudinally movable toward and away from the fixed pipe jaw(s); (iii) a fusion zone between the fixed and movable pipe jaws; (iv) an indexer carriage which is longitudinally movable from side-to-side adjacent to the fixed and movable pipe jaws; (v) a facer carried by the indexer carriage such that the facer is downwardly pivotable to an operating position in the fusion zone and upwardly pivotable to a retracted position; (vi) a heater carried by the indexer carriage such that the heater is downwardly pivotable to an operating position in the fusion zone and upwardly pivotable to a retracted position; (viii) one or more heater biasing elements in the indexer carriage which continuously urge the heater upwardly to its retracted position; (ix) a latch which holds the heater in its operating position; (x) a heater stripping mechanism; (xi) a latch release mechanism; and (xii) a brake assembly which is carried by the indexer carriage.

In another aspect, there is provided a heater retention mechanism which does not interfere with the downward rotation of the heater but can be used to retain the heater at one or more intermediate positions as the heater is pivoted downwardly toward the fusion zone from its fully retracted position. When the operator releases the heater at a selected intermediate position, the heater retention mechanism prevents the heater from automatically returning to its fully retracted position. This allows the operator to have both hands free at one or more intermediate positions which are convenient for cleaning the heater, taking surface temperature readings, or other purposes.

In another aspect, the heater retention mechanism preferably comprises (i) a retention ring which rotates with the heater, (ii) a ratchet pawl which interacts with one or more ratchet cogs provided on the retention ring as the heater is pivoted downward, and (iii) a toggle assembly. The toggle assembly automatically acts to engage the ratchet pawl when, or as, the heater is received in the fusion zone so that the heater retention mechanism is disengaged and will not interfere with the subsequent return rotation of the heater from the fusion zone back to its fully retracted position. But then as, or when, the heater returns to its fully retracted position, the toggle assemble will automatically release the ratchet pawl to thereby reset the heater retention mechanism for operation of the retention mechanism when the heater is again pivoted downwardly toward the fusion zone.

In another aspect, when the heating operation of the heater is completed, the heater stripping mechanism is preferably operable for automatically freeing the heater in the fusion zone, if needed, from the molten end of the pipe section held by the fixed jaw(s) and/or the molten end of the pipe section held by the movable jaw(s). The latch release assembly is preferably operable for then automatically releasing the latch so that the heater biasing elements automatically pivot the heater upward to its retracted position.

The brake assembly carried by the carriage assembly preferably (a) disengages when the heater is latched in the fusion zone to permit the indexer carriage and the heater to move longitudinally from side-to-side, (b) engages as the heater is pivoted out of the fusion zone to prevent the indexer carriage and the heater from moving longitudinally from side-to-side, and (c) remains engaged at least until the heater is removed from the fusion zone.

In another aspect, there is provided a method of fusing pipe sections together. The method preferably comprises the steps of: (a) pivoting a heater downwardly to an operating position in a fusion zone such that the heater is positioned between the end of a first pipe section held by one or more fixed pipe jaws and an opposing end of a second pipe section held by one or more movable pipe jaws, the movable pipe jaw(s) being longitudinally movable toward and away from the fixed pipe jaw(s) and the heater being pivotably held by a carrier; (b) latching the heater in the operating position and heating the opposing ends of the first and second pipe sections; (c) after heating the opposing ends of the first and second pipe sections, automatically detaching the heater, if needed, from the end of the first pipe section and/or the end of the second pipe section; (d) after step (c), automatically unlatching the heater and automatically pivoting the heater upwardly out of the fusion zone to a retracted position using one or more biasing elements, held by the carrier, which continuously urge the heater upwardly to its retracted position; (e) automatically releasing a brake for the carriage during step (b) to allow the heater to move longitudinally from side-to-side during step (b); (f) automatically engaging the brake when step (d) begins to prevent the heater from moving longitudinally from side-to-side; and (g) maintaining the engagement of the brake in step (d) at least until the heater is out of the fusion zone.

Further objects, features, and advantages of the present invention will be apparent to those in the art upon examining the accompanying drawings and upon reading the following Detailed Description of the Preferred Embodiments.

### BRIEF DESCRIPTION OF THE DRAWINGS

FIG. 1 is an elevational side view of an embodiment 2 of the pipe fusion apparatus provided by the present invention.

FIGS. 2A and 2B show a partially disassembled view of the inventive pipe fusion apparatus 2.

FIG. 3 is an elevational view of a facer 22 used in the inventive apparatus 2.

FIG. 4 is a perspective view of an indexer assembly 16 used in the inventive apparatus 2.

FIG. 5 is an exploded view of a heater linkage assembly 30 used in the inventive apparatus 2.

FIG. 6 is an elevational side view of the heater linkage assembly 30.

FIG. 7 is an elevational front view of the heater linkage assembly 30.

FIGS. 8A and 8B show a side view of the indexer assembly 16.

FIGS. 9A and 9B show another side view of the indexer assembly 16.

FIGS. 10A and 10B show another side view of the indexer assembly 16.

FIGS. 11A and 11B show another side view of the indexer assembly 16.

FIGS. 12A and 12B show another side view of the indexer assembly 16.

FIGS. 13A and 13B show another side view of the indexer assembly 16.

FIG. 14 provides a perspective view of a carriage brake assembly 38 used in the inventive apparatus 2.

FIG. 15 is another perspective view of the carriage brake assembly 38.

FIG. 16 is an exploded view of the carriage brake assembly 38.

FIG. 17 is an exploded view of an assembly for a Tee-bar 116 used in the carriage brake assembly 38.

FIG. 18 is another exploded view of the carriage brake assembly 38.

FIGS. 19A and 19B show a vertical side view of the inventive apparatus 2.

FIGS. 20A and 20B show another vertical side view of the inventive apparatus 2.

FIG. 21 illustrates an alternative brake assembly 180 for the inventive fusion apparatus.

FIG. 22 illustrates another alternative brake assembly 190 for the inventive fusion apparatus.

FIGS. 23A and 23B illustrate another alternative brake assembly 200 for the inventive fusion apparatus.

FIG. 24 illustrates an alternative stripping mechanism 210 for the inventive fusion apparatus.

FIG. 25 further illustrates the alternative stripping mechanism 210.

FIG. 26 further illustrates the alternative stripping mechanism 210.

FIG. 27 further illustrates the alternative stripping mechanism 210.

FIG. 28 further illustrates the alternative stripping mechanism 210.

FIG. 29 is a rear perspective view of an alternative embodiment 300 of the indexer carriage assembly used in the inventive pipe fusion apparatus 2.

FIG. 30 is a front perspective view of the indexer carriage assembly 300.

FIG. 31 is an elevational side view of the indexer carriage assembly 300.

FIG. 32 is a perspective view of a heater indexer retention assembly 302 used in the indexer carriage assembly 300.

FIG. 33 is an exploded view of the heater indexer retention assembly 302.

FIG. 34 is an exploded view of a portion of the heater indexer retention assembly 302.

FIG. 35 is a front view of an alternative embodiment 380 of an automatic heater stripping system used in the inventive pipe fusion apparatus 2.

### DETAILED DESCRIPTION OF THE PREFERRED EMBODIMENTS

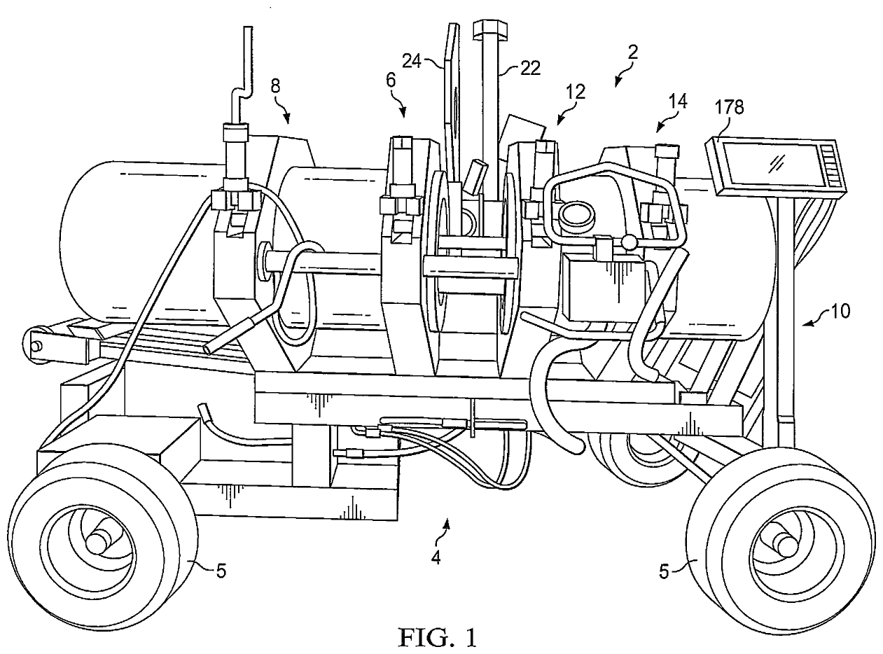

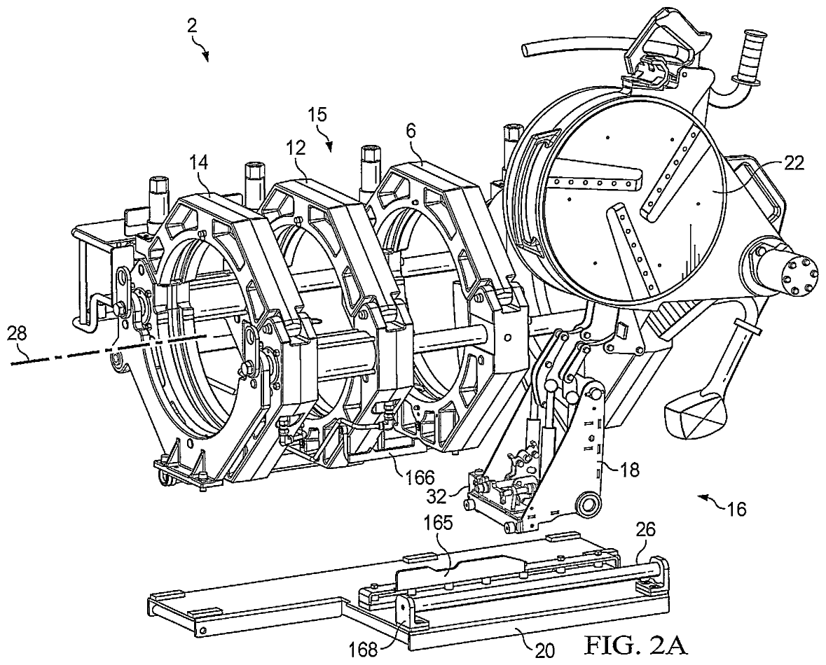

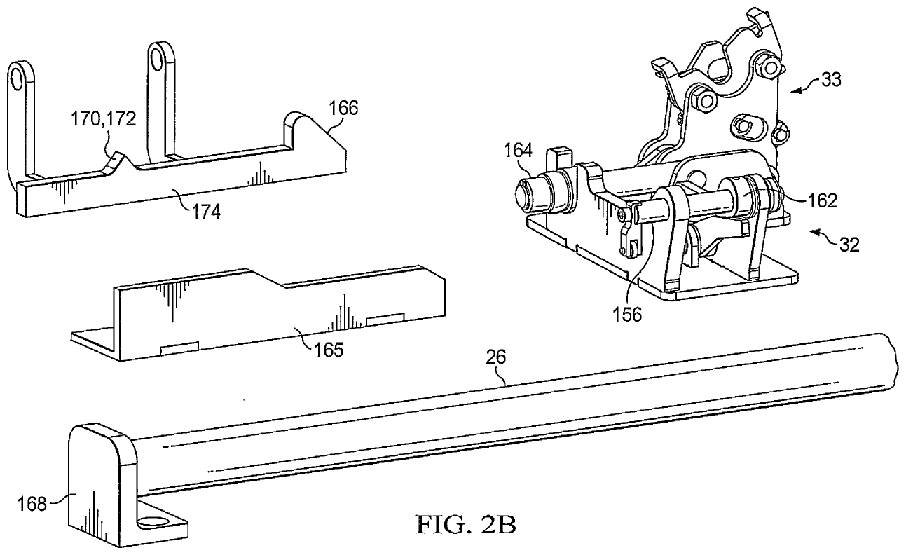

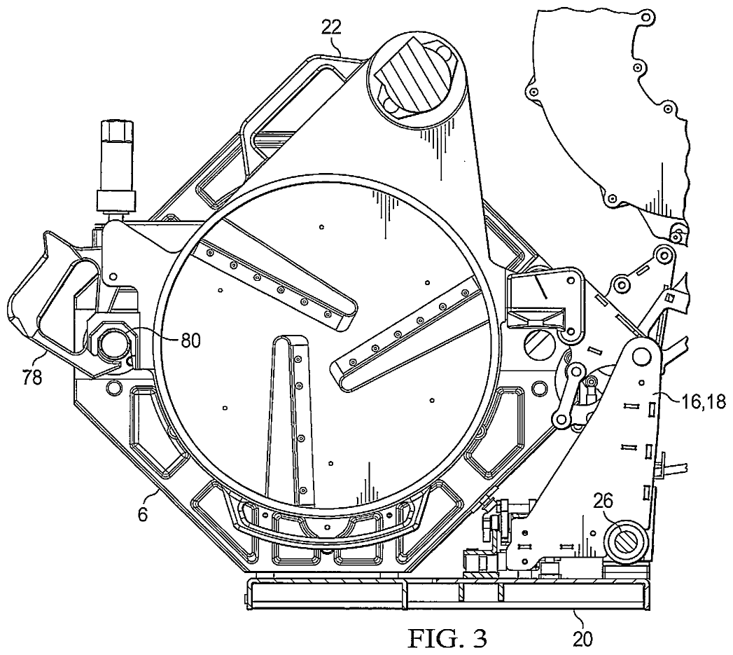

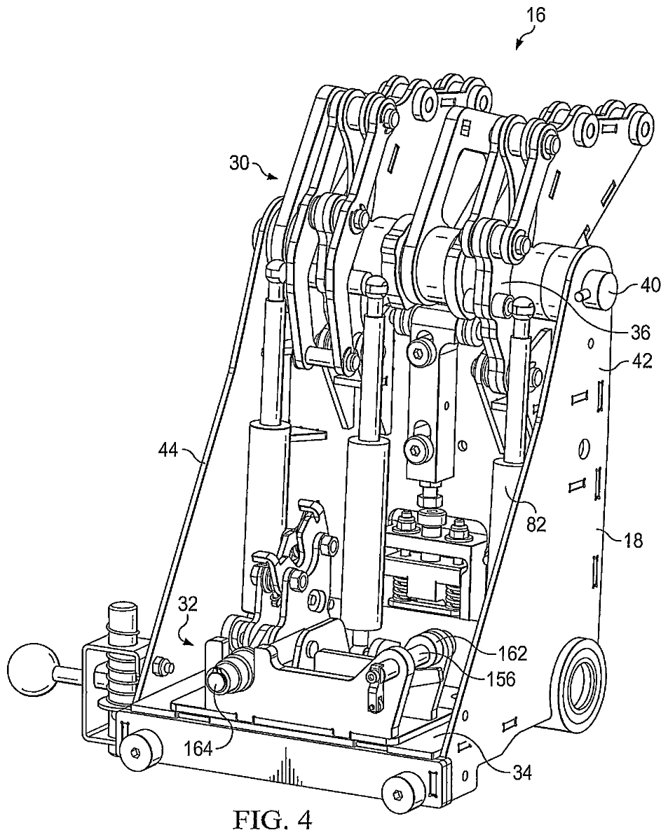

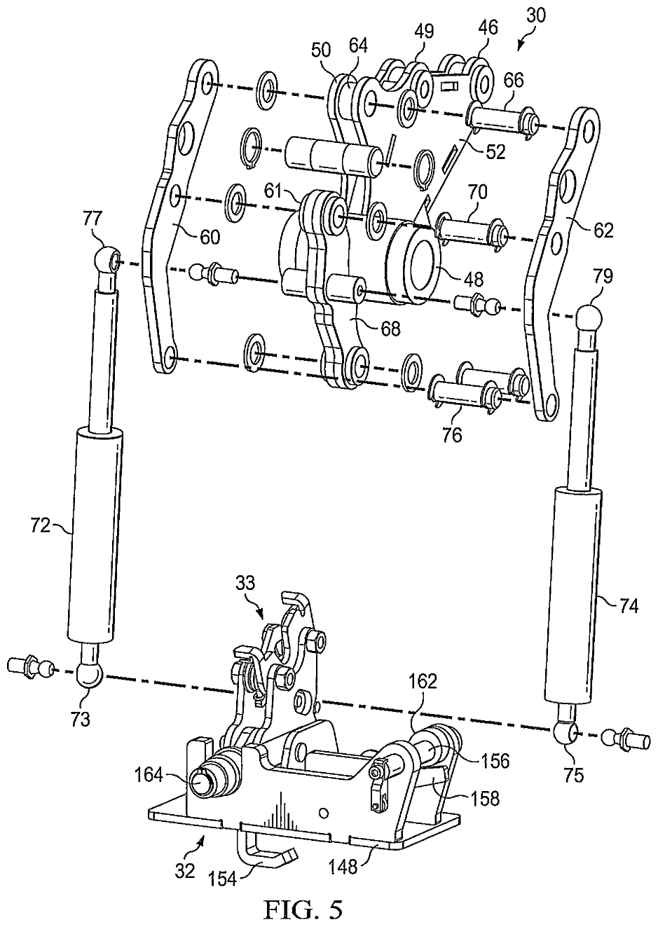

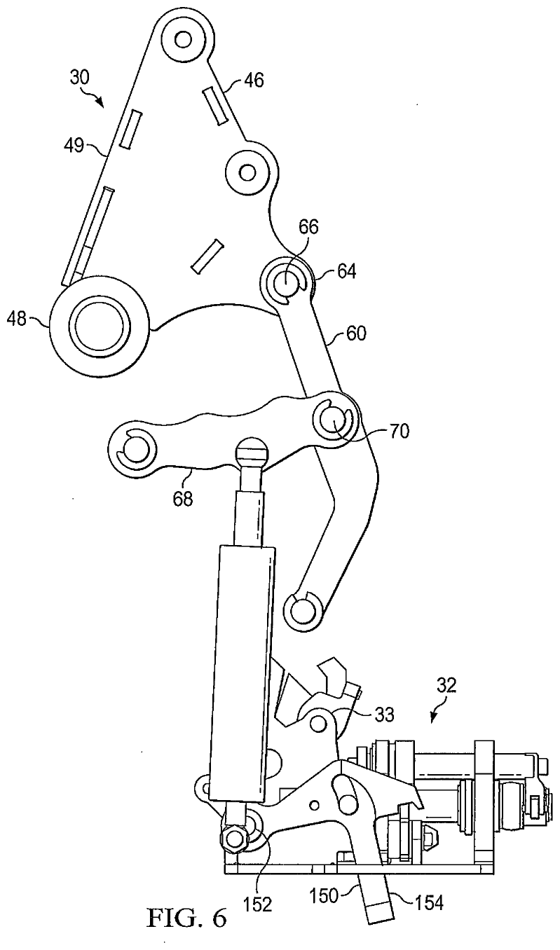

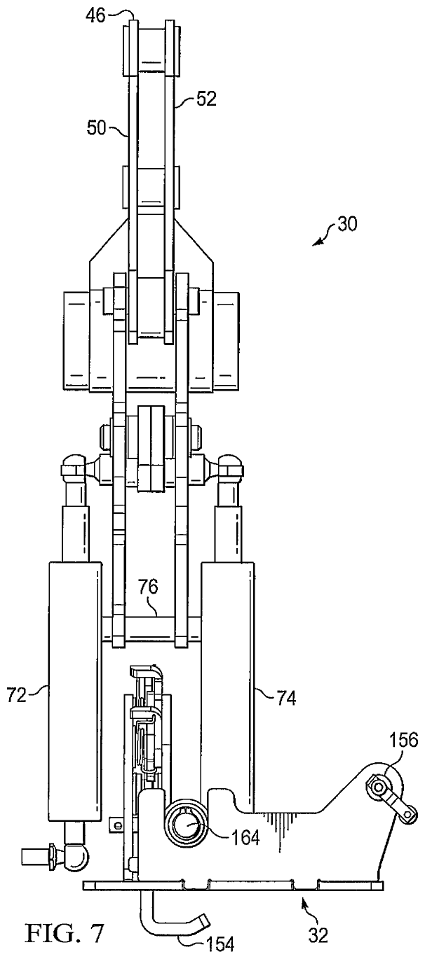

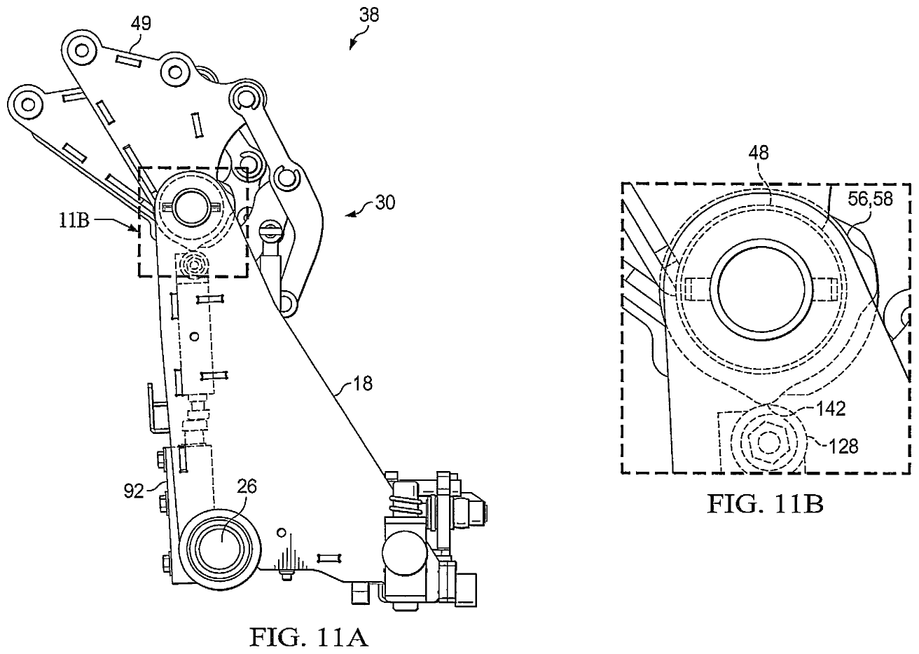

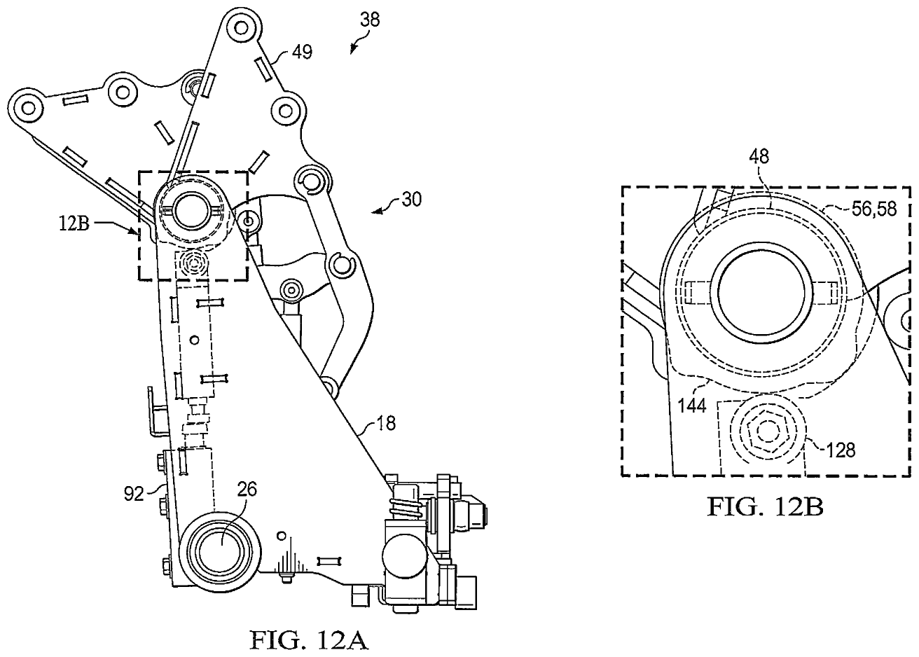

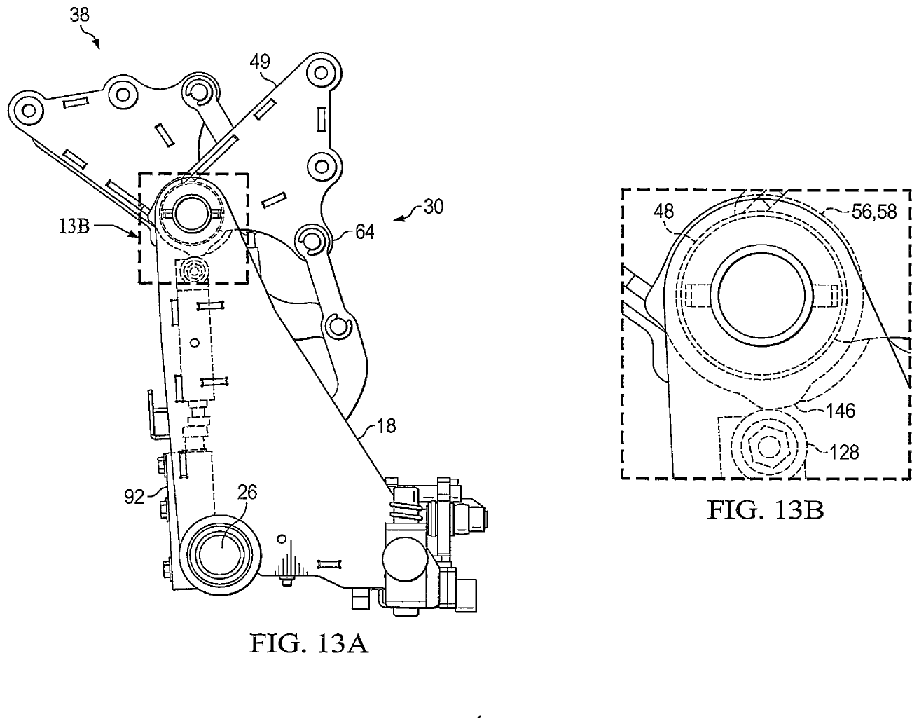

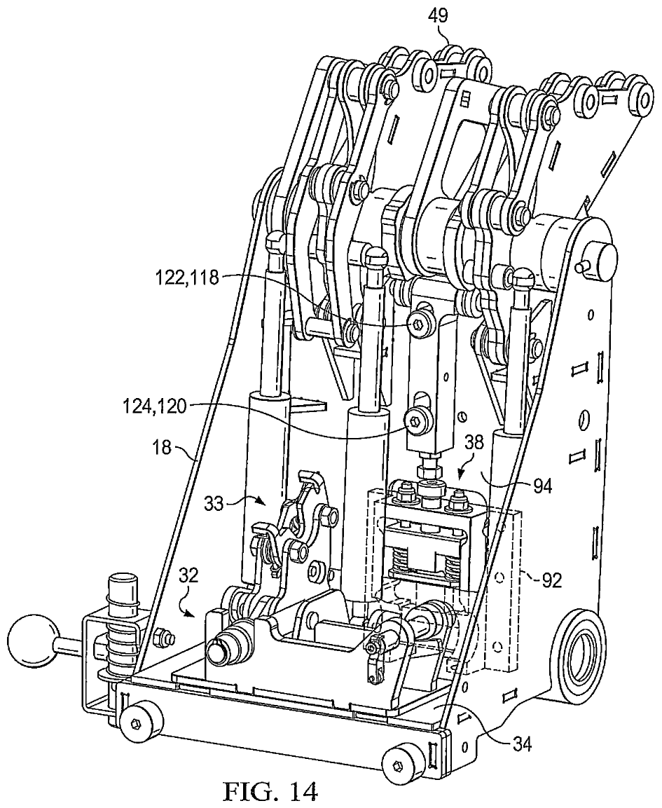

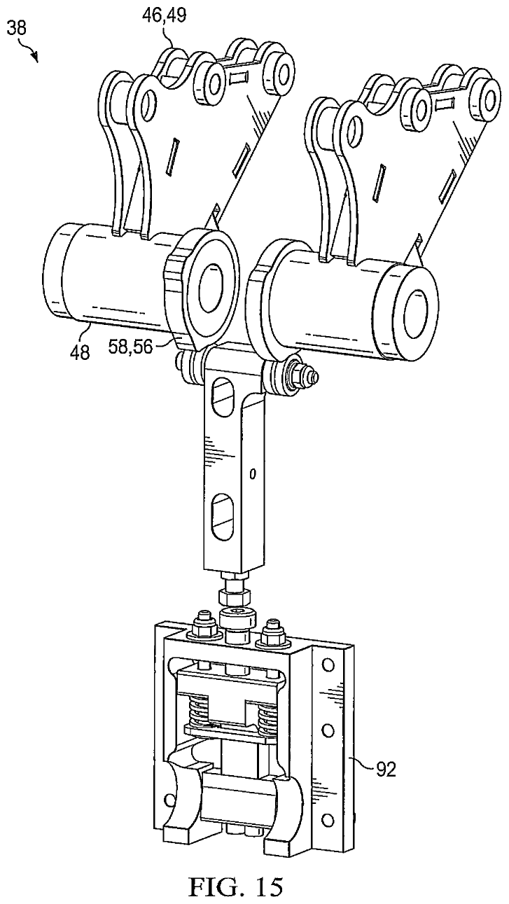

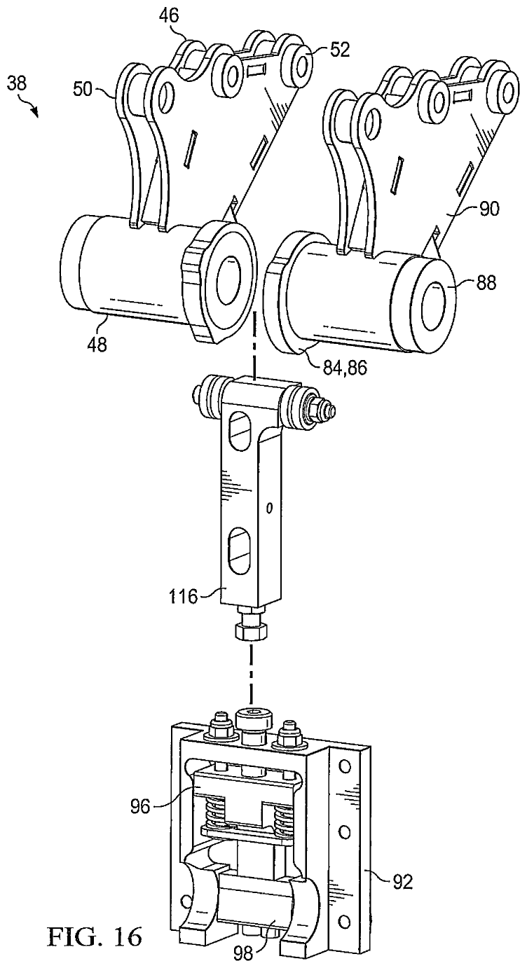

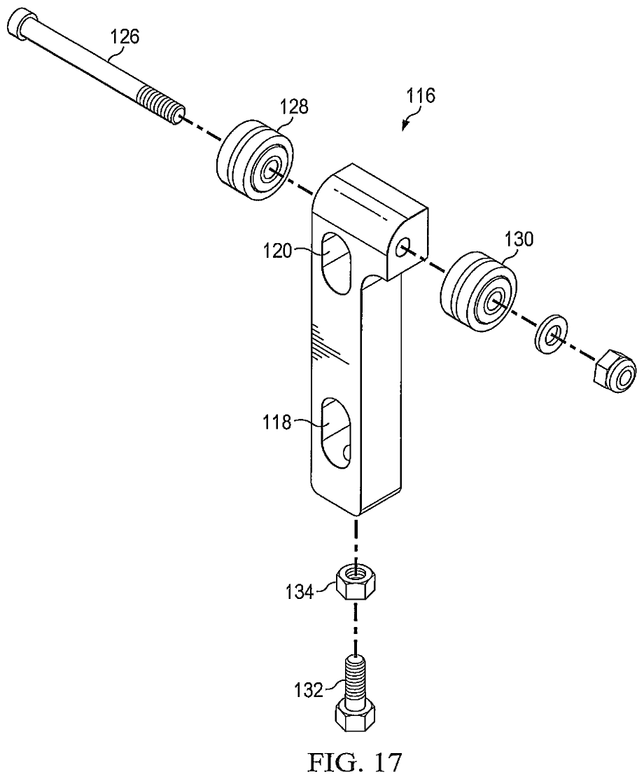

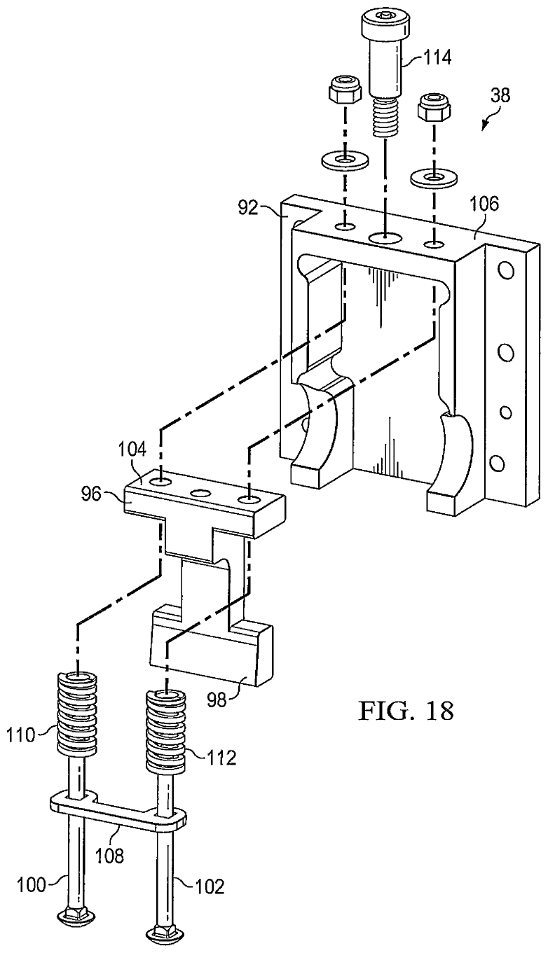

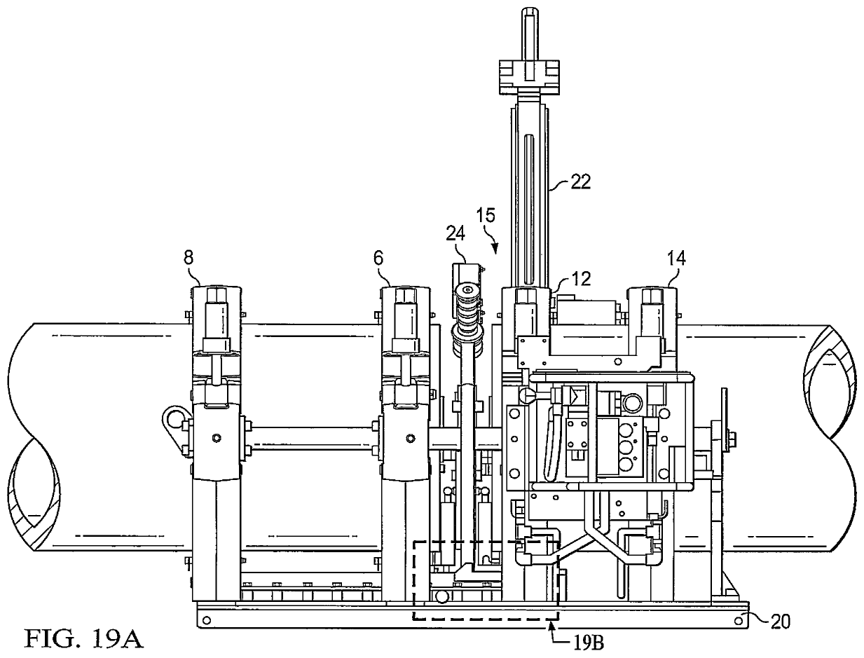

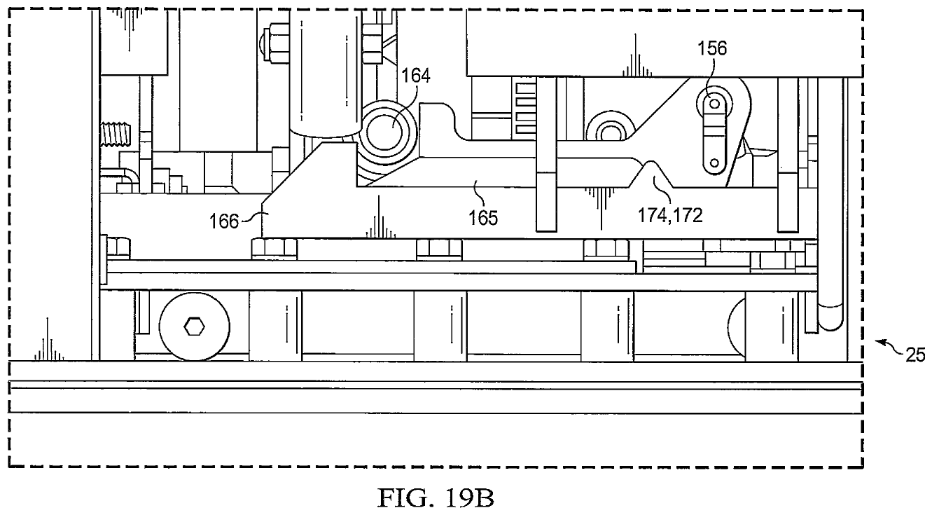

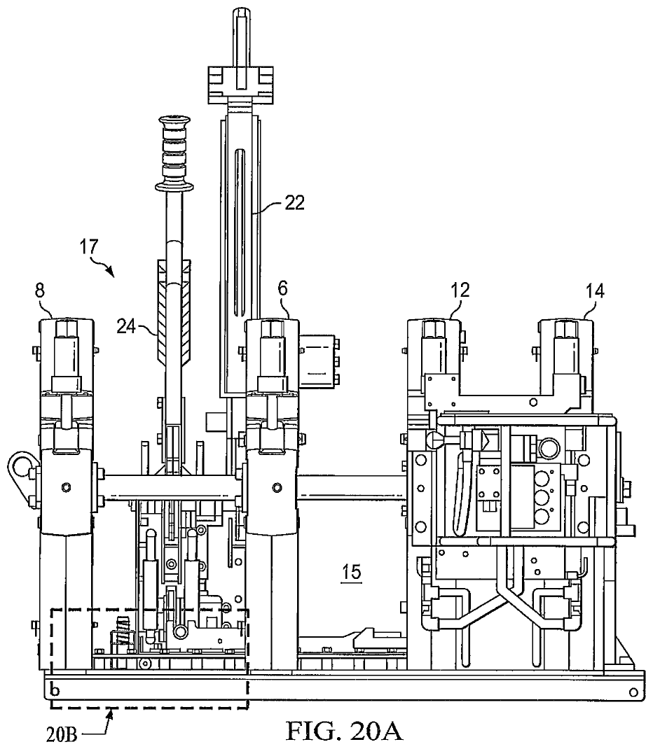

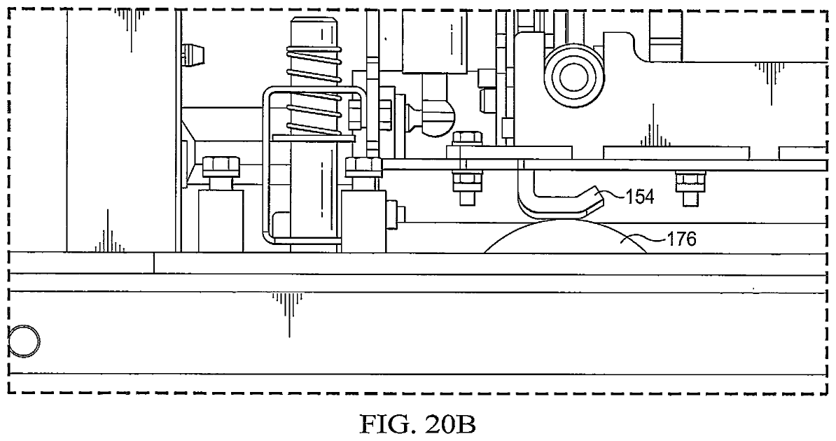

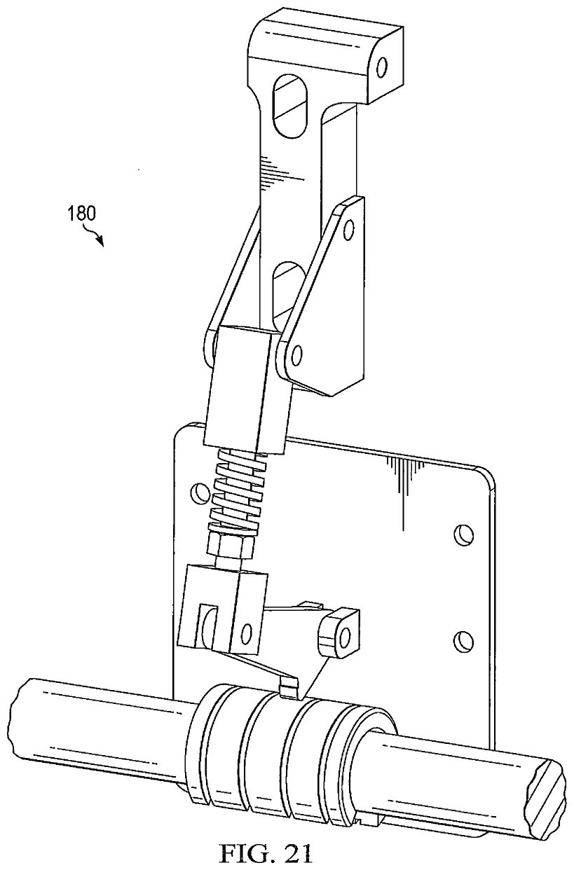

An embodiment 2 of the inventive pipe fusion machine is illustrated in FIGS. 1, 2A, 2B, 3-7, 9A, 9B, 10A, 10B, 11A, 11B, 12A, 12B, 13A, 13B, 14-18, 19A, 19B, 20A, and 20B. The inventive pipe fusion apparatus 2 comprises: (i) a base frame or other base 4 (e.g., a vehicle chassis with wheels 5 or tracks); (ii) one or more, preferably a pair, of fixed pipe jaws 6, 8 mounted on the base 4; (iii) a fusion carriage 10 which is mounted on the base 4 for reciprocating longitudinal movement; (iv) one or more, preferably a pair, of movable pipe jaws 12, 14 which are mounted on and carried by the fusion carriage 10 for longitudinal movement toward and away from the fixed pipe jaws 6, 8; (v) a central longitudinal axis 28 which extends through the pipe jaws 6, 8, 12, 14; (vi) a fusion zone 15 between the inner fixed pipe jaw 6 and the inner movable pipe jaw 12; (vii) an indexer assembly 16 which comprises an indexer carriage 18 and an indexer platform 20 on which the indexer carriage 18 is mounted for side-to-side movement parallel to the longitudinal axis 28; (viii) a facer 22 which is carried by the indexer carriage 18; (ix) a heater 24 which is also carried by the indexer carriage 18; (x) a heater latch and release assembly 32 which includes a heater latch 33; and (xi) an automatic heater stripping system 25.

The indexer platform 20 for the indexer carriage 18 is mounted in fixed position on the base 4 and preferably comprises a horizontal linear guide member (e.g., a rod or rail) 26 for the indexer carriage 18. The linear guide member 26 on the indexer platform 20 runs parallel to the longitudinal axis 28 and extends through the left and right sides of the indexer carriage 18 for sliding side-to-side movement of the of the indexer carriage 18 along the linear guide member 26 parallel to the longitudinal axis 28.

The indexer assembly 16 of the inventive fusion machine 2 preferably also comprises: (i) a heater linkage assembly 30 which is positioned within and carried by the indexer carriage 18 for rotating the heater 24 between a fully retracted (i.e., fully raised) position and an operating position in the fusion zone 15; (ii) a heater latch and release assembly 32 positioned on the floor 34 of the indexer carriage 18; (iii) a facer linkage assembly 36 which is positioned within and carried by the indexer carriage 18 for rotating the facer 22 between a fully retracted (i.e., fully raised) position and an operating position in the fusion zone 15; (iv) a lateral pivot rod 40 for the heater and facer linkage assemblies 30 and 36 which extends through the upper portion of the left side wall 42 and the upper portion of the right side wall 44 of the indexer carriage 18; and (v) a carriage brake assembly 38 positioned within the indexer carriage 18.

The heater linkage assembly 30 preferably comprises a heater arm structure 46 which is pivotably retained on the pivot rod 40. The heater arm structure 46 includes: (i) a pivot barrel 48 through which the lateral pivot rod 40 is received; (ii) a heater attachment bracket 49 which extends radially from and is perpendicular to the pivot barrel 48; (iv) a radial rim 56 which extends around the inner end of the pivot barrel 48; and (v) a heater cam profile 58 which is formed on the radial rim 56 for operating the carriage brake assembly 38. The heater attachment bracket 49 is preferably formed of a pair of opposing bracket plates 50 and 52 between which a mounting plate of the heater 24 is received and attached.

The heater linkage assembly 30 further comprises: (1) an opposing pair of curved outer linkage arm plates 60 and 62; (2) a projecting lower elbow 64 of the heater attachment bracket 49 which is positioned between the upper end portions of the outer linkage arm plates 60 and 62; (3) a pivot pin 66 which extends through the upper end portions of the outer linkage arm plates 60 and 62 and through the projecting lower elbow 64 of the heater attachment bracket 49 which is positioned between the plates 60 and 62; (4) a spring arm 68 having a first end 61 which is positioned at an intermediate location between the outer linkage arm plates 60 and 62; (5) a pivot pin 70 which extends through the outer linkage arm plates 60 and 62 and through the first end 61 of the spring arm 68 which is positioned between the plates 60 and 62; (6) a pair of gas springs 72 and 74, or other biasing elements, having lower ends 73, 75 which are pivotably attached at the floor 34 of the indexer carriage 18 and upper ends 77, 79 which are pivotably attached on opposite outer sides of an intermediate portion of the spring arm 68; and (7) a latch element (e.g., a pin or bar) 76 which is secured between the lower end portions of the outer linkage arm plates 60 and 62.

The latch element 76 of the heater linkage assembly 30 is receivable in the heater latch 33 for holding the heater 24 in the fusion zone until the latch 33 is automatically released. When the heater latch 33 is released, the gas springs or other biasing elements 72 and 74 then operate to automatically push the heater 24 upwardly from the fusion zone 15 to its fully retracted position.

The facer linkage assembly 36 for the facer 22 is essentially the same as the heater linkage assembly 30 except for three basic differences. First, because the facer 22 has its own latch 78 which receives a latch pin 80 that projects longitudinally into the fusion zone 15 from the fixed pipe jaw 6, the lower end portions of the outer linkage arm plates 60 and 62 of the heater linkage assembly 30, and the latch element 76 which extends therebetween, are not included in the facer linkage assembly 36.

Second, since, unlike the heater 24, the facer 22 will be manually unlatched and pivoted upwardly from the fusion zone 15 to its retracted position, the facer linkage assembly 36 preferably has only one gas spring or other biasing element 82 which provides ergonomic assistance to the operator when raising the facer 22.

Third, as will be discussed in more detail below, the cam profile 84 formed on the radial rim 86 around the pivot barrel 88 of the facer arm structure 90 is different from the cam profile 58 of the heater linkage assembly 30.

The carriage brake assembly 38 of the inventive fusion apparatus 2 preferably comprises: (i) a brake support structure 92 which is positioned within, and is preferably attached to the vertical back wall 94 of, the indexer carriage 18; (ii) a brake element 96 having a braking surface 98 (preferably a braking wedge) which is provided on the lower end thereof for contacting the linear guide member 26 which runs through the indexer carriage 18; (iii) a pair of brake guide pins or bolts 100 and 102 which extend vertically through an upper Tee 104 of the brake element 96 and through an upper wall 106 of the brake support structure 92 for sliding up and down movement of the brake element 96 on the brake guide pins or bolts 100 and 102; (iv) a horizontal spring plate 108 through which the upper portions of the brake guide pins or bolts 100 and 102 extend, and which rests on and is held by support shoulders (not shown) formed around the brake guide pins or bolts 100 and 102; and (v) a pair of biasing elements, preferably coil springs and most preferably die springs, 110 and 112 which are positioned on the upper portions of the brake guide pins or bolts 100 and 102 between the spring plate 108 and the upper Tee 104 of the brake element 96.

The brake springs or other biasing elements 110 and 112 continuously urge the brake element 96 upwardly toward a default position in which the braking wedge or other braking surface 98 of the brake element 96 is in contact with the linear guide member 26 which runs through the indexer carriage 18. When the brake element 96 is in braking contact with the linear guide member 26, the indexer carriage 18, as well as the facer 22 and the heater 24 which are carried by the indexer carriage 18, are prevented from moving from side-to-side along the linear guide member 26 parallel to the longitudinal axis 28 of the pipe jaws 6, 8, 12, 14.

For releasing the carriage brake 38 at desired stages of the pipe facing, heating, and fusion operations, the carriage brake assembly 38 preferably further comprises: (a) a bolt or rod, preferably a shoulder bolt, 114 which slideably extends vertically through the upper wall 106 of the brake support 92 and has a lower end which is in contact with the upper end of the brake element 96; (b) a vertical Tee-bar 116 having vertical slots 118 and 120 with fasteners, preferably bolts and most preferably shoulder bolts, 122 and 124 extending therethrough for attaching the Tee-bar 116 to the back wall 94 of the indexer carriage 18 such that the vertical Tee-bar 116 is permitted to move upwardly and downwardly on the bolts or other fasteners 122 and 124; (c) a bearing shaft 126 which extends laterally through the upper end of the Tee-bar 116; (d) a heater cam follower, preferably a cam follower bearing, 128 which is rotatably held by the bearing shaft 126 on one side of the upper end of the Tee-bar 116 for engagement with, and for following, the cam profile 58 of the heater linkage assembly 30; (e) a facer cam follower, preferably a cam follower bearing, 130 which is rotatably held by the bearing shaft 126 on the opposite side of the upper end of the Tee-bar 116 for engagement with, and for following, the cam profile 84 of the facer linkage assembly 36; (f) a bolt 132 which extends downwardly from the bottom end of the Tee-bar 116 for contacting the upper end of the shoulder bolt 114 which extends upwardly from the brake element 96; and (g) a jam nut 134 for locking the bolt 132 in position for proper operation of the carriage brake assembly 38 and for adjusting the bolt 132 as needed to compensate for wear.

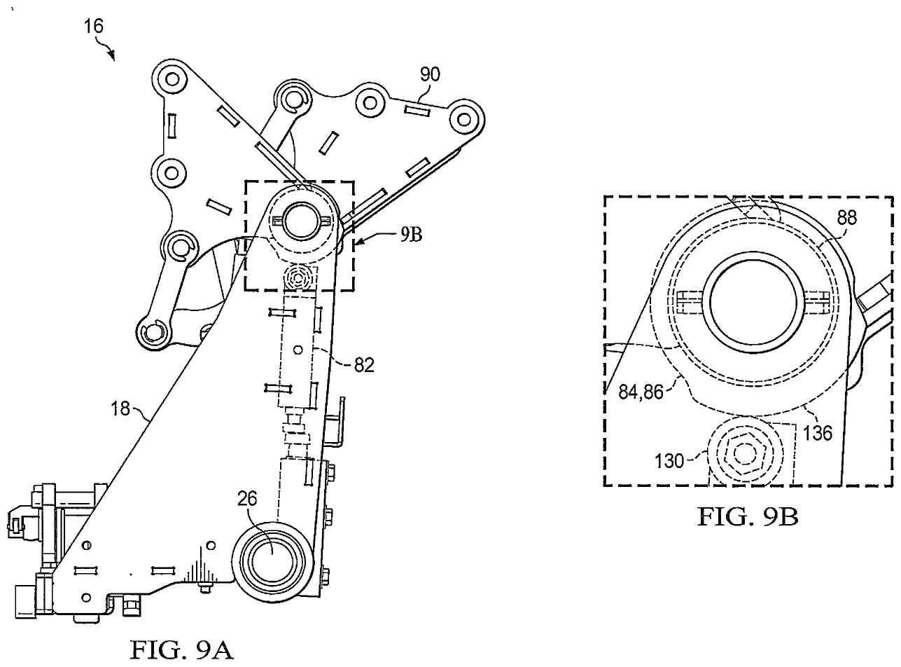

As illustrated in FIGS. 9A and 9B, when the facer 22 is pivoted fully downward so that the facer 22 is positioned in the fusion zone 15, a projecting radial portion 136 of the cam profile 84 of the facer linkage assembly 36 contacts the facer cam follower 130 of the carriage brake assembly 38. This forces the facer cam follower 130 and the Tee-bar 116 downward, which in turn pushes the brake element 96 downward so that braking surface 98 does not contact the linear carriage guide member 26. Thus, the brake assembly 38 is released (i.e., the braking surface 98 does not contact the linear guide member 26) when the facer 22 is positioned in the fusion zone 15, thereby allowing the indexer carriage 18 and the facer 22 to freely move from side-to-side, parallel to the longitudinal axis 28 of the pipe jaws 6, 8, 12, 14, during the facing operation.

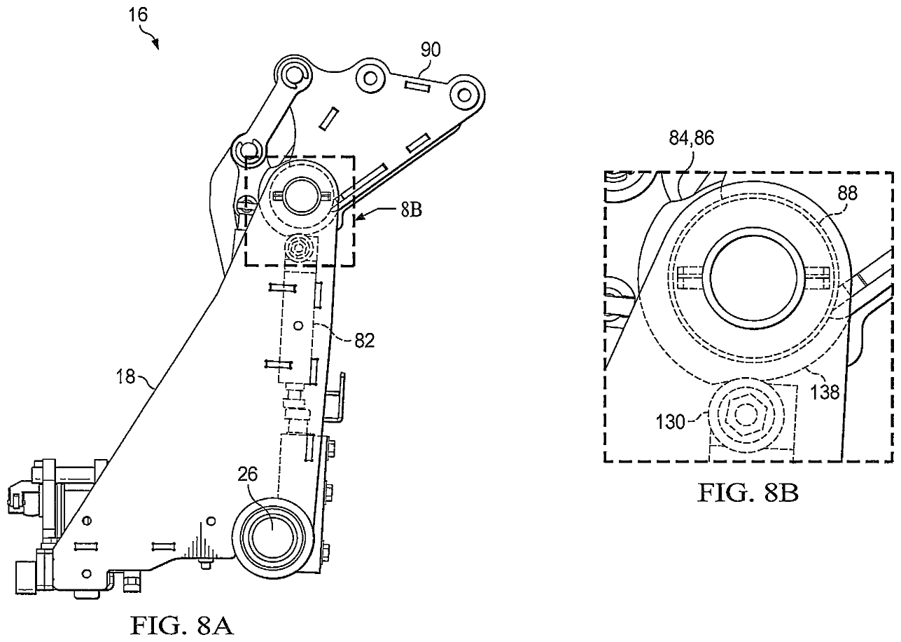

However, as illustrated in FIGS. 8A and 8B, when the facer 22 is pivoted upwardly, the facer cam profile 84 rotates such that a radially recessed portion 138 of the facer cam profile 84 moves into contact with the facer cam follower 130, which thereby allows the brake element 96 and the Tee-bar 116 to move upwardly, as urged by the brake springs or other biasing elements 110 and 112. Consequently, when the facer 22 is pivoted upwardly out of the fusion zone 15 to its retracted position, the facer linkage assembly 36 does not operate to release the carriage brake assembly 38. This does not, however, prevent the heater linkage assembly 30 from releasing the carriage brake assembly 38 as needed.

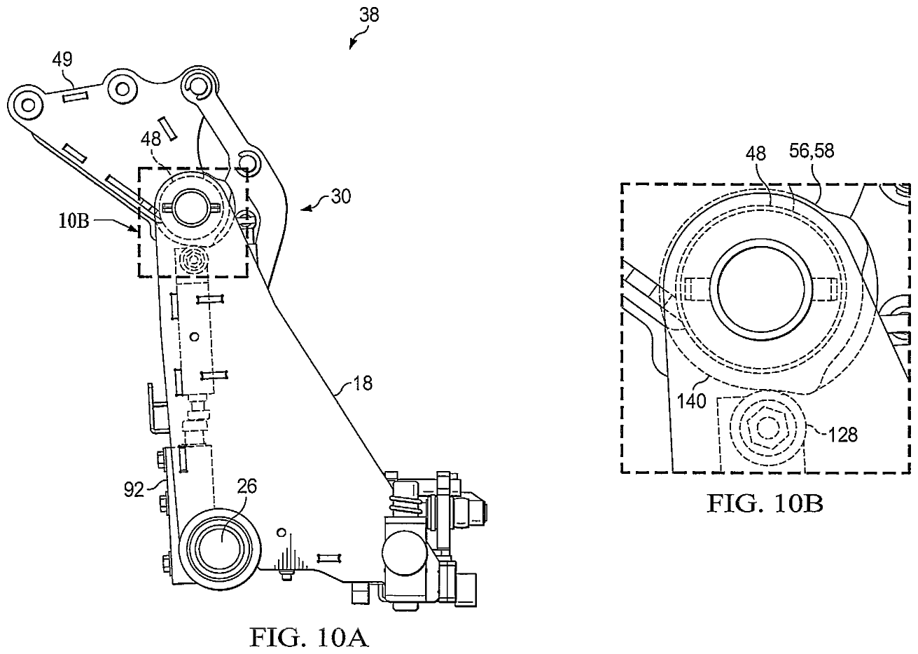

As sequentially illustrated in FIGS. 10A, 10B, 11A, 11B, 12A, 12B, 13A, 13B, when the heater 24 is pivoted upwardly to its fully retracted position, a radially recessed portion 140 of the heater cam profile 58 moves into contact which the heater cam follower 128, which allows the brake springs or other biasing elements 110 and 112 to move the brake element 96 and the Tee-bar 116 upwardly, unless prevented from doing so by the facer linkage assembly 36, so that the brake assembly 38 is engaged (i.e., the braking surface 98 is in frictional/braking contact with the linear guide member 26 of the indexer carriage 18).

Next, as the heater 24 is pivoted partially downward, a projecting tab 142 of the heater cam profile 58 rotates into contact with the heater cam follower 128 which pushes the Tee-bar 116 and the brake element 96 downward to release the brake assembly 38 so that the indexer carriage 18 is permitted to move from side-to-side for proper alignment of the heater 24 with the fusion zone 15.

Then, as the heater 24 is pivoted further downward, a second recessed portion 144 of the heater cam profile 58 rotates into contact with the heater cam follower 128 so that the brake springs or other biasing elements 110 and 112 are permitted to urge the brake element 96 and the Tee-bar 116 upwardly to thereby engage the carriage brake assembly 38 to prevent the indexer carriage 18 and the heater 24 from moving from side-to-side as the heater 24 moves into the fusion zone 15.

Finally, when the heater 24 moves fully downward to its locked position in the fusion zone 15, a second projecting tab 146 of the heater cam profile 58 rotates into contact with the heater cam follower 128, thereby pushing the Tee-bar 116 and the brake element 96 downward to release the carriage brake assembly 38 so that the heater 24 is permitted to move from side-to-side in the fusion zone 15 during the heating, melting and beading process.

At the end of the heating and stripping processes, the heater 24 is automatically unlatched and then automatically rotated upwardly by the gas springs or other biasing elements 72 and 74 of the heater linkage assembly 30 from the fusion zone 15 to its fully retracted position. As the heater 24 is pivoted upwardly, the cam profile 58 of the heater linkage assembly 30 operates the carriage brake assembly 38 in the same manner as described above, but in the reverse order.

Consequently, as the heater 24 moves upwardly out of the fusion zone 15, the second recessed portion 144 of the heater cam profile 58 causes the carriage brake assembly 38 to automatically engage so that the heater 24 is prevented from moving from side-to-side and coming into contact with the molten ends of the pipe sections. Then, when the heater 24 has pivoted upwardly a sufficient distance that it is clear of the fusion zone 15, the projecting tab 142 of the heater cam profile 58 operates to momentarily release the carriage brake assembly 38. Finally, as the heater moves into its fully retracted position, the radial recessed portion 140 of the heater cam profile 58 permits the carriage brake assembly 38 to engage and prevent side-to-side movement of the indexer carriage 18, unless the carriage brake assembly 38 is disengaged by the facer linkage assembly 36.

By way of example, but not by way of limitation, the latch 33 used in the heater latch and release assembly 32 can be a rotational push-to-close latch. An example of a rotational push-to-close latch which is well-suited for use in the inventive pipe fusion apparatus 2 is commercially available from Southco Inc.

The heater latch and release assembly 32 preferably further comprises: (a) a latch frame 148, positioned on the floor 34 of the indexer carriage 18, which holds the latch 32; (b) a latch release lever 150 which is pivotably attached to the latch frame 148 at a pivot point 152 for releasing the latch 32; (c) a release foot 154 which extends downwardly from the release lever 150 through the bottom of the frame 148; (d) a release shaft 156 which extends laterally with respect to the longitudinal axis 28 and is rotatably held by the latch frame 148; (e) a release lever lifting arm 158 which is pivotably held by the latch frame 148 and has a lifting end which is positioned beneath the latch release lever 150; and (f) a cam 162 which extends radially from the release shaft 156 for contacting, and pushing downwardly on, the opposite end of the release lever lifting arm 158 to pivot the lifting end of the release lever lifting arm 158 upwardly to thereby lift and trip the latch release lever 150.

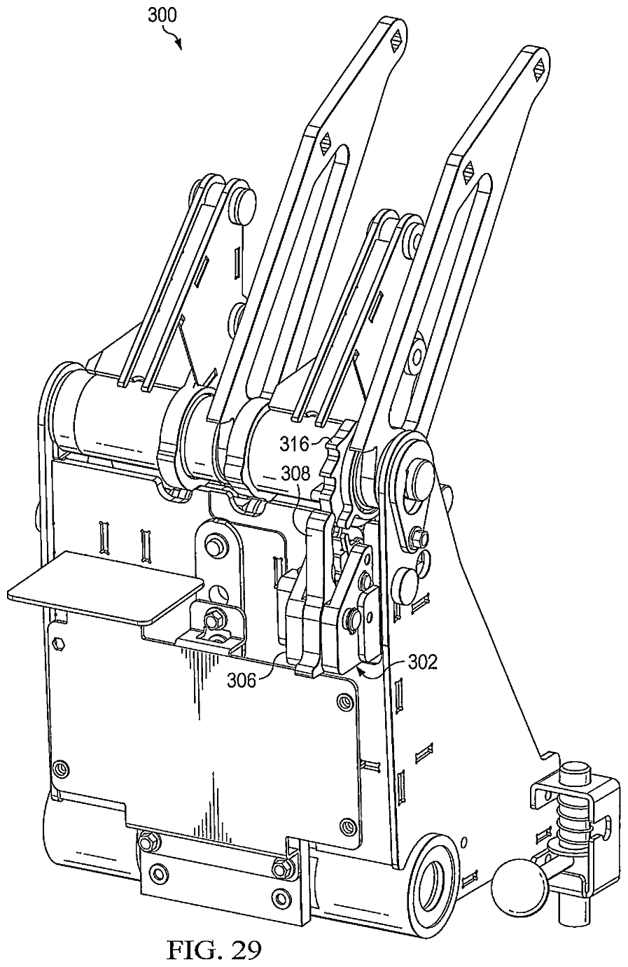

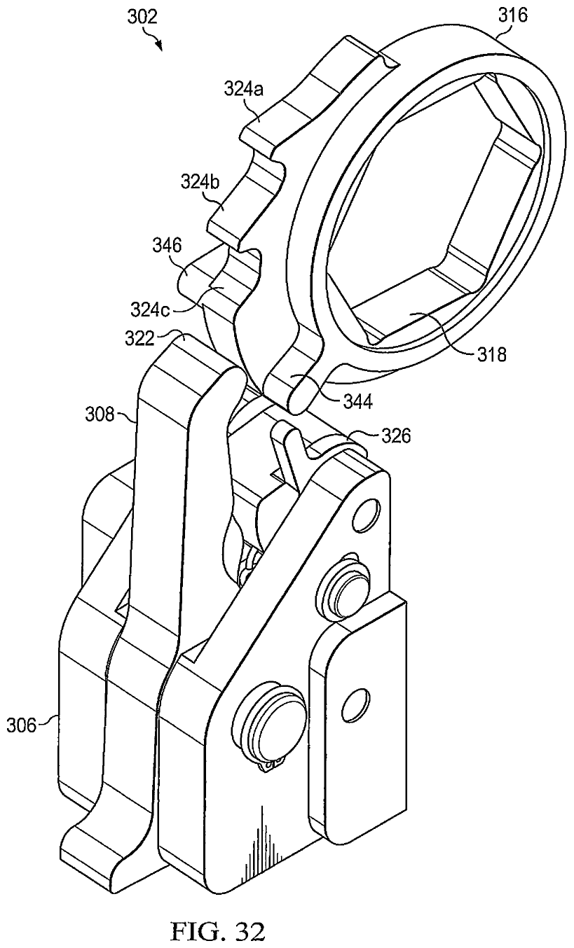

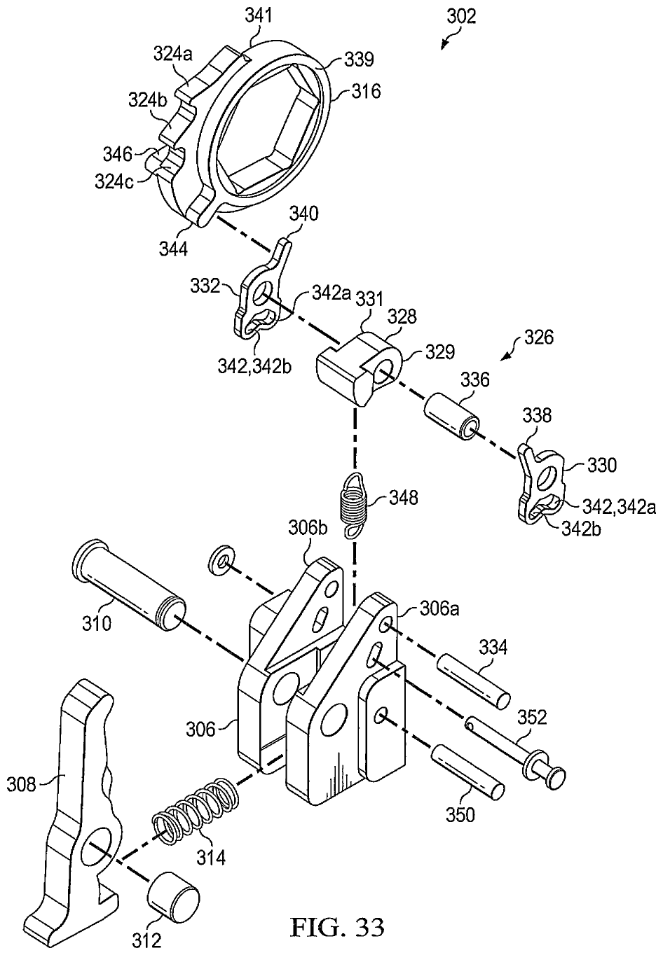

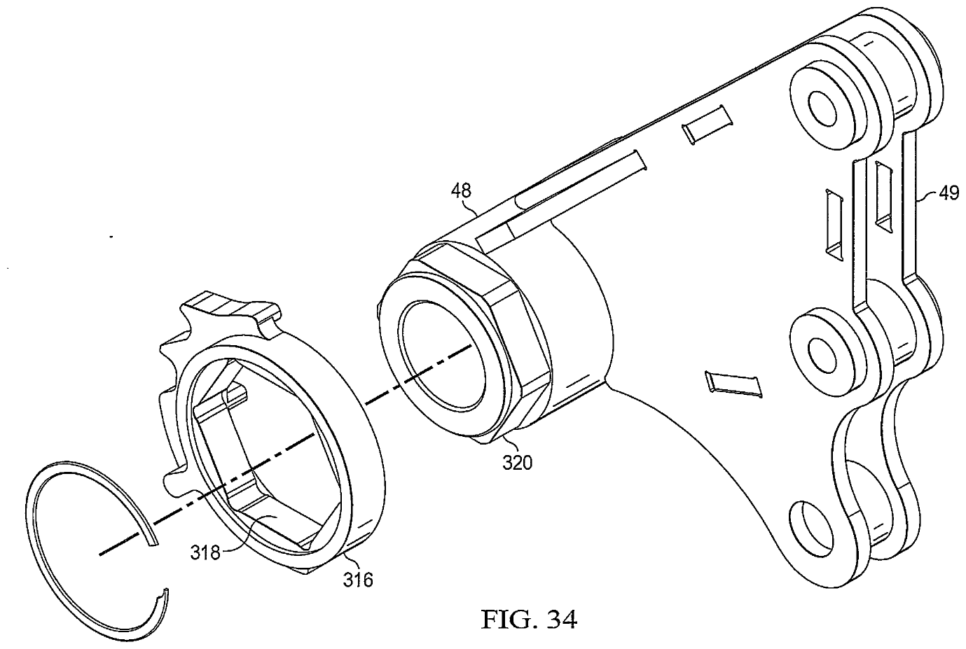

An alternative embodiment 300 of the indexer carriage used in the indexer assembly 16 of the inventive fusion machine 2 is illustrated in FIGS. 29-34. The indexer carriage 300 is essentially the same as the indexer carriage 18 described above except that the indexer carriage 300 (i) includes a heater indexer retention assembly 302 and (ii) replaces the latch 33 of the heater latch and release assembly 32 with an elbow latch 362.

As the operator pulls the heater 24 downward from its fully retracted position toward the fusion zone 15, the heater indexer retention assembly 302 of the indexer carriage 300 will retain the heater 24 in one or more (preferably a plurality of) intermediate ratchet positions to prevent the heater from rotating in the reverse direction back toward its outward retracted position. In other words, if, during the downstroke of the heater 24, the operator releases the handle of the heater 24, the gas springs or other biasing elements 72 and 74 will be prevented by the indexer retention assembly 302 from automatically rotating the heater 24 outward, in the reverse direction, past the nearest intermediate ratchet point. This permits the operator to pull the heater downward to a desired intermediate retention position and then release the handle of the heater 24 in order to have both hands free for inspecting or cleaning the heater 24, taking surface temperature readings, etc.

However, when the heater 24 is received in its downward operating position in the fusion zone 15, the heater indexer retention assembly 302 is automatically disengaged so that the heater indexer retention assembly 302 does not interfere with the outward rotation of the heater 24 back to its fully retracted position once the heating procedure is completed and the heater 24 has been automatically stripped, if needed, from the heated end of the fixed pipe segment or the heated end of the movable pipe segment. But subsequently, as the heater 24 approaches its outward, fully retracted position, the heater indexer retention assembly 302 automatically resets for operation during the next downstroke of the heater 24.

The heater indexer retention assembly 302 preferably comprises: (i) a retention body 306 attached on the outer side of the back wall 94 of the indexer carriage 18, the body 306 preferably comprising a pair of opposing body plates 306a and 306b; (ii) a retention ratchet pawl 308 which is pivotably mounted between the body plates 306a and 306b on a mounting pin 310 which extends through the pawl 308; (iii) a rotary bushing 312, for the ratchet pawl 308, which is also provided around the mounting pin 310; (iv) a heater retention ring 316 which is provided on the pivot barrel 48 of the heater attachment bracket 49 and is locked for rotation with the heater attachment bracket 49 by an internal locking profile, preferably a hex profile, 318 of the retention ring 316 which mates with a corresponding external hex or other locking profile 320 of the pivot barrel 48; and (v) a pawl biasing spring 314, within the body 306, which engages the lower portion of the ratchet pawl 308 to continuously urge a tooth 322 on the upper end of the ratchet pawl 308 toward engagement with one or more, preferably a plurality of, cogs 324a, 324b which project from the perimeter of the retention ring 316.

The heater indexer retention assembly 302 also comprises a toggle assembly 326 which acts to automatically (a) disengage the heater indexer retention assembly 302 when the heater 24 is received in its downward operating position in the fusion zone 15 and (b) reset the heater indexer retention assembly 302 when the heater 24 returns to its fully retracted position after the heating operation.

The toggle assembly 326 preferably comprises: a toggle element 328; a first side plate 330 on one lateral side of the toggle element 329; and an opposing second side plate 332 on the opposite lateral side of the toggle element 331. The toggle assembly 326 is pivotably mounted in the retention body 306 on a toggle mounting pin 334 which extends through the toggle element 328 and through the first and second side plates 330 and 332, wherein a bushing 336 for the toggle assembly 326 is also provided on the toggle mounting pin 334.

The first and second side plates 330 and 332 of the toggle assembly 326 have (a) upper rocker arms 338 and 340 which are positioned on opposite lateral sides 339 and 341 of the heater retention ring 316 and (b) a lower opening 342 which comprises a forward lobe 342a and a rearward lobe 342b. The second side plate 332 is a mirror image of the first side plate 330 except that (i) the rocker arm 338 of the first side plate 330 is rearwardly oriented to engage a shoulder 344 on the lateral side 339 of the retention ring 316 and (ii) the rocker arm 340 of the second side plate 332 is forwardly oriented to engage a shoulder 346 on the opposite lateral side 341 of the retention ring 316.

A toggle biasing spring 348 is also provided in the body 306 of the heater indexer retention assembly 302 wherein (a) a lower end of the toggle spring 348 is held by a pin 350 which extends through the retention body 306 and (b) a toggle engaging pin 352 extends through the upper end of the toggle spring 348. The toggle engaging pin 352 also extends through the lower openings 342 of the first and second toggle side plates 330 and 332. When the toggle assembly 326 is pivoted forwardly, the toggle engaging pin 352 on the upper end of the toggle spring 348 automatically shifts from the rearward lobes 342b to the forward lobes 342a of the lower openings 342 of the toggle side plates 330 and 332. When the toggle assembly 326 is pivoted rearwardly, the toggle engaging pin 352 on the upper end of the toggle spring 348 automatically shifts from the forward lobes 342a to the rearward lobes 342b of the lower openings 342 of the toggle side plates 330 and 332.

When the heater 24 is in its fully retracted outward position, the engaging pin 352 of the toggle spring 348 is in the forward lobes 342a of the lower openings 342 of the toggle side plates 330 and 332 wherein the toggle spring 348 holds the toggle assembly 326 in a forwardly pivoted position such that the toggle element 328 is not in contact with the ratchet pawl 308. This allows the ratchet pawl 308 to pivot forwardly and engage the heater retention ring 316 as the operator pivots the heater 24 downward.

Consequently, if desired, the heater 24 can be retained at a first intermediate position by (a) pivoting the heater 24 downwardly such that the upper tooth 322 of the ratchet pawl 308 is positioned between the first cog 324a and the second cog 324b of retention ring 316 and then (b) releasing the heater 24 such that the pawl 308 catches the first cog 324a to prevent the heater 24 from being pivoted further outward by the gas springs 72 and 74. Similarly, the heater 24 can be retained at a second (lower) intermediate position by (a) pivoting the heater 24 further downward such that the upper tooth 322 of the ratchet pawl 308 is between the second cog 324b and the third cog 324c and then (b) releasing the heater 24.

As the operator continues to pull the heater 24 downward past the second intermediate position toward the fusion zone 15, the shoulder 344 on the first side 339 of the retention ring 316 engages the rearwardly oriented rocker arm 338 of the toggle assembly 326 and pivots the toggle assembly 326 rearwardly so that (i) the toggle element 328 engages the ratchet pawl 308 and pivots the pawl 308 rearwardly, away from engagement with the heater retention ring 316, and (ii) the engaging pin 352 on the upper end of the toggle spring 348 automatically shifts to the rearward lobes 342b of the lower openings 342 of the toggle assembly side plates 330 and 332 to thereby hold the toggle element 328 and the ratchet pawl 308 in their rearwardly pivoted positions so that the pawl 308 will not engage the cogs 324a, 324b of the retention ring 316. As a result, when the heater 24 is released from the fusion zone 15 at the end of the heating operation, the gas springs or other biasing elements 72 and 74 are allowed to freely pivot the heater 24 outwardly to its fully retracted position.

However, as the heater 24 pivots outwardly toward its fully retracted position such that the first cog 324a of the retention ring 316 has rotated downwardly past the tooth 322 at the upper end of the ratchet pawl 308, the shoulder 346 on the opposite side 341 of the heater retention ring 316 engages the forwardly oriented rocker arm 340 of the toggle assembly 326 which automatically (a) pivots the toggle element 328 forwardly out of engagement with the ratchet pawl 308 and (b) shifts the engaging pin 352 on the upper end of the toggle spring 348 back to the forward lobes 324a of the lower openings 342 of the toggle side plates 330 and 332 such that the toggle spring 348 holds the toggle assembly 326 in its forwardly pivoted position. This resets the heater indexer retention assembly 302 so that the ratchet pawl 308 will once again engage the cogs 324a, 324b of the heater retention ring 316 when the heater 24 is pivoted downwardly toward the fusion zone 15.

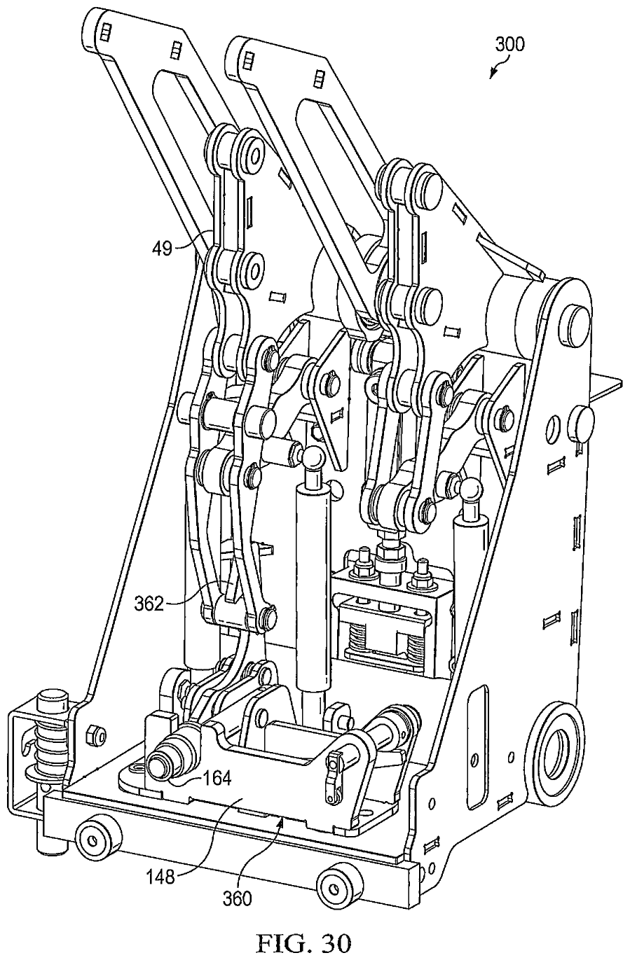

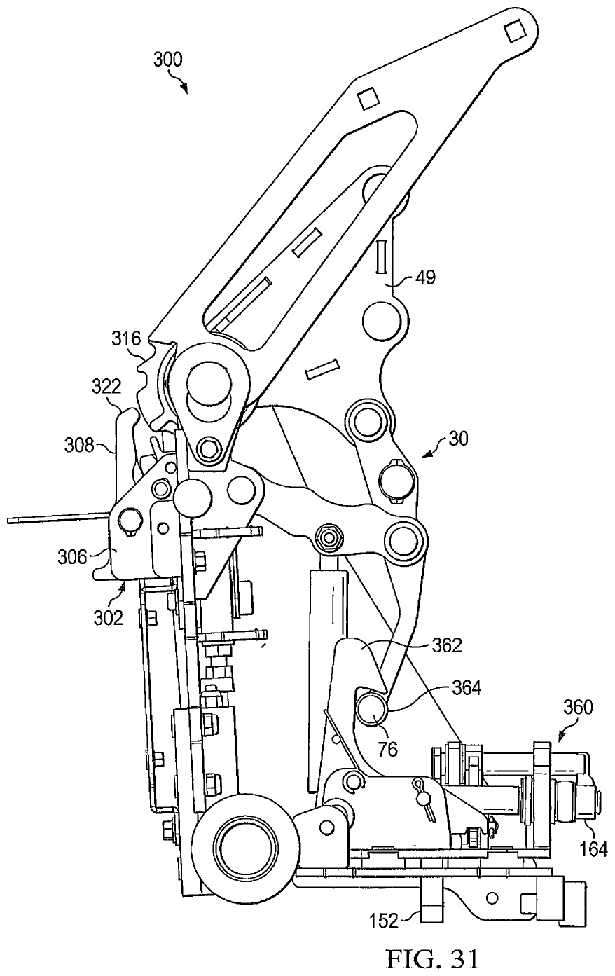

An alternative embodiment 360 of the heater latch and release assembly is illustrated in FIGS. 30 and 31. The heater latch and release assembly 360 is the same as the assembly 32 described above except that, as mentioned above, the push-to-close latch 33 is replaced with an elbow latch 362 which is part of or connected to the latch release lever 150. In addition, a bearing 364 is used for mounting the heater latch element 76 between the lower end portions of the outer arm plates 60 and 62 of the heater linkage assembly 30 so that, when it contacts the elbow latch 362, the latch pin 76 will rotate freely rather than abrading the elbow latch 362.

The elbow latch 362 is capable of pivoting throughout its range of motion with the heater latch element 76 remaining in the same location (i.e., without the heater latch element 76 being required to rotate downwardly or upwardly to any degree), thus reducing wear and eliminating the need for any corresponding movement of the heater 24 itself until it is released.

During the heating process, the heater 24 may become stuck to either or both of the molten end of the pipe held by the fixed pipe jaws 6 and 8 and/or the molten end of the pipe held by the movable pipe jaws 12 and 14. Consequently, before the heater latch release mechanism is automatically tripped to release the heater 24, the automatic heater stripping system 25 must first operate to detach the heater 24 from the molten ends of the two pipe sections.

The heater stripping system 25 preferably comprises: (1) a stripping rod 164 which is held by the latch frame 148, or is otherwise held by the indexer carriage 18, such that the stripping rod 164 extends laterally with respect to the longitudinal axis 28 and can be lifted or pivoted upwardly; (2) a stripping hook structure 166 which extends longitudinally from the movable pipe jaw 12 into the fusion zone 15 for catching the stripping rod 164; (3) a ramp or other lifting structure 165, preferably positioned on the indexer platform 20 parallel to the linear guide element 26, for lifting the stripping rod 164 to release the stripping hook 166; and (4) a travel stop 168 extending upwardly from the indexer platform 20 (e.g., an upwardly extending end support for the linear guide member 26) for the indexer carriage 18.

After the heating operation, before tripping the heater latch release mechanism, the fusion carriage 10 moves the movable pipe jaws 12 and 14 longitudinally outward, away from the fixed jaws 6 and 8. As the movable jaws 12 and 14 move outward, if the heater 24 is stuck to the fixed pipe or otherwise does not move with the movable jaws 12 and 14, the stripping hook 166 catches the indexer carriage stripping rod 164 so that the indexer carriage 18 and the heater 24 are pulled outwardly as well, which strips the heater 24 from the molten end of the fixed pipe section if needed. Then, as the movable jaws 12 and 14 and the indexer carriage 18 continue to move outward, the indexer carriage stripping rod 164 is lifted as it rides up the ramp 165, which thereby releases the indexer carriage stripping rod 164 from the stripping hook 166.

However, if the heater 24 is stuck to the molten end of the pipe section held by the movable pipe jaws 12 and 14, the indexer carriage 18 will continue to move outwardly with the movable pipe jaws 12 and 14 until the indexer carriage 18 contacts the travel stop 168 on the indexer platform 20. This stops the outward movement of the indexer carriage 18 and the heater 24 so that, as the movable jaws 12 and 14 then continue to move outward, the molten end of the pipe carried by the movable jaws 12 and 14 detaches from the heater 24.

Once the molten ends of the pipe sections are stripped from the heater 24 and the outward movement of the indexer carriage 18 has been stopped, the heater latch release mechanism is automatically triggered by a trigger mechanism 170 which rotates the heater release shaft 156 so that the cam 162 on the shaft 156 pivots the lifting end of the heater release lever lifting arm 158 upward to trip the heater latch release lever 150. The trigger mechanism 170 for releasing the latch 33 or the elbow latch 362 is preferably an upwardly projecting tab 172 on the elongate arm 174 of the stripping hook structure 166. As the movable pipe jaws 12 and 14 continue to move outward, but with the movement of the indexer carriage 18 stopped, the elongate arm 174 of the stripping hook 166 travels under the heater release shaft 156 until the upwardly projecting tab 172 catches a corresponding tab or other structure on the heater release shaft 156 and thereby causes the release shaft 156, and the cam 162 thereon, to rotate.

The heater release foot 154 which extends downwardly from heater latch release lever 150 provides an alternative method for releasing the heater latch 33 or the elbow latch 362 without operating the fusion carriage 10 of the inventive fusion machine 2. This method is advantageous, for example, for releasing the heater 24 from a storage and transport position where the heater 24 and the facer 22 are both latched in a storage zone 17, preferably located in the space between the fixed pipe jaws 6 and 8. To release the heater latch 33 using the heater release foot 154, the operator simply pushes the indexer carriage 18 longitudinally until the release foot 154 rides up a ramp 176 on the indexer platform 20 such that the release foot 154 is pivoted upwardly to its release position.

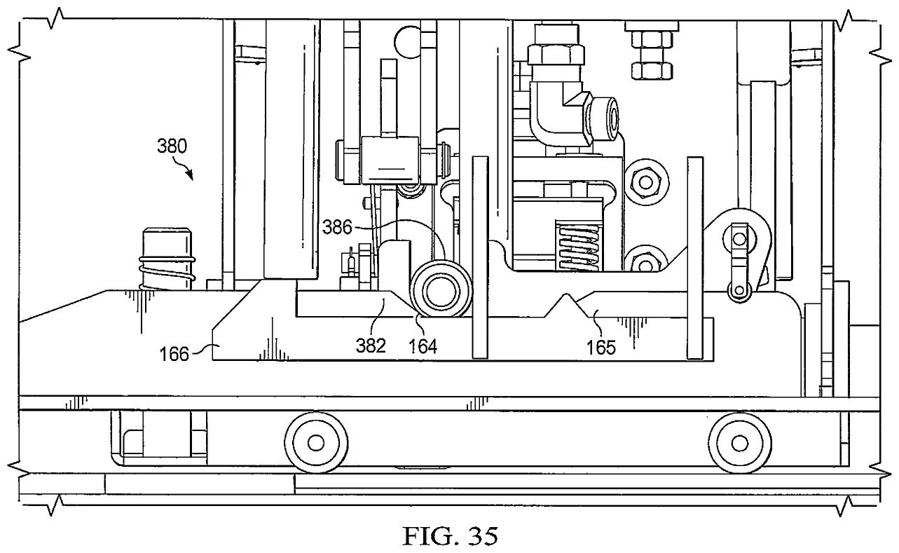

An alternative embodiment 380 of the automatic heater stripping system is illustrated in FIG. 35. The automatic heater stripping system 380 is essentially the same as the stripping system 25 described above except that, in addition to having a ramp or other lifting structure 165 which engages and lifts the stripping rod 164 as the stripping hook 166 pulls the indexer carriage 18 or 300 longitudinally away from the fixed pipe jaws 6 and 8, the stripping system 380 also includes a second ramp or other lifting structure 382. The second ramp 382, which is also provided on the indexer platform 20, will engage and lift the stripping rod 164, if needed, as the indexer carriage 18 or 300 is moved in the opposite direction.

After the fusion operation, the indexer carriage 18 or 300 must be moved toward the fixed pipe jaws 6 and 8 in order to allow the pipe jaws 6, 8, 12, and 14 to be opened so that the fused pipe can be removed. The addition of the second ramp or other lifting structure 382 in the automatic heater stripping system 380 enables the indexer carriage 18 or 300 to be moved to the extent needed after fusion even when only a minimum amount of material was removed from the ends of the fixed and movable pipe segments during the facing operation.

If needed as the indexer carriage 18 or 300 is being moved after the fusion operation, the stripping rod 164 (which preferably has a crowned release bearing 386 thereon for rotation) is able to roll up the second ramp 382, thus allowing the stripping rod 164 to clear the stripping hook 166 so that the indexer carriage 18 or 300 can continue to move in that direction. This allows the indexer 16 to move horizontally out of the way of the upper jaws 6, 8, 12, and 14 so that they can be opened and the fused pipe removed, even when the minimum amount of material was removed from the ends of the pipe segments during facing.

In the method of the present invention, the inventive fusion apparatus 2 is used to fuse the ends of two pipe sections together. In the inventive method, the facer 22 is manually pivoted downward into the fusion zone 15, between the ends of the pipe sections, and is locked into position by the facer latch 78. The latch 78 prevents the facer 22 from pivoting upwardly during the facing operation.

As the facer 22 reaches its latched position in the fusion zone 15, the projecting radial portion 136 of the facer cam profile 84 pushes the facer cam follower 130 downward. This releases the carriage brake assembly 38 so that, during the facing procedure, the indexer carriage 18 or 300 and the facer 22 are permitted to freely move from side-to-side, parallel to the longitudinal axis 28. This permits the end of the pipe carried by the movable pipe jaws 12 and 14 to push the facer 22 into tight engagement between the pipe sections, and to maintain the tight engagement as the facer 22 removes material from ends of the pipes.

At the end of the facing procedure, the fusion carriage 10 carries the movable jaws 12 and 14 and the movable section of pipe longitudinally away from the fixed jaws 6 and 8. The facer latch 78 is then released and, with the assistance of the gas spring or other biasing element 82 of the facer linkage assembly 36, the facer 22 is manually pivoted upwardly out of the fusion zone 15 to its fully retracted position. As the facer 22 pivots upwardly, the recessed portion 138 of the facer cam profile 84 rotates into contact with the facer cam follower 130, which thereby engages the carriage brake assembly 38 so that, unless and until the brake assembly 38 is disengaged by the heater linkage assembly 30, the indexer carriage 18 or 300 is prevented from moving from side-to-side when the facer 22 is in its retracted position.

After the removal of the facer 22, the heater 24 is manually pivoted downward into the fusion zone 15 until the latch element 76 of the heater linkage assembly 30 is received in the heater latch 33 or 362 to lock the heater 24 in its operating position. The heater latch 33 or 362 prevents the heater 24 from being pivoted upwardly out of the fusion zone by the gas springs or other biasing elements 72 and 74 until after the heating operation is completed.

In the fusion zone 15, until the heater 24 reaches its latched position, the recessed portion 144 of the heater cam profile 58 contacts the heater cam follower 128 so that the carriage brake assembly 38 is engaged and the indexer carriage 18 or 300 and the heater 24 are prevented from moving from side-to-side.

However, as the latch element 76 is received in the heater latch 33 or 362, the projecting tab 146 of the heater cam profile 58 rotates into contact with the heater cam follower 128. This releases the carriage brake assembly 38 so that, during the heating procedure, the indexer carriage 18 or 300 and the heater 24 are permitted to freely move from side-to-side, parallel to the longitudinal axis 28. This allows the end of the pipe carried by the movable pipe jaws to 12 and 14 to push the heater 24 into tight engagement between the pipe sections, and to maintain the tight engagement during the heating, melting, and beading process.

At the end of the heating process, an automated control system 178, or a manual control, causes the fusion carriage 10 to move the movable pipe jaws 12 and 14 and the movable section of pipe outwardly away from the fixed jaws 6 and 8. If the heater 24 is stuck to the molten end of the movably section of pipe, the heater 24 and the indexer carriage 18 or 300 will also move outwardly with the movable pipe jaws 12 and 14.

However, if the heater 24 is stuck to the molten end of the fixed pipe, or is not stuck to the end of either pipe, the heater 24 and the indexer carriage 18 or 300 will not move until the continued outward movement of the movable pipe jaws 12 and 14 causes the stripping hook 166, which extends into the fusion zone 15 from the movable jaw 12, to catch the indexer carriage stripping rod 164. The fusion carriage 10 and the movable jaw 12 then pull the indexer carriage 18 or 300 and the heater 24 longitudinally outward, which also causes the heater 24 to detach from the molten end of the fixed pipe section if needed.

As the fusion carriage 10 and the movable jaw 12 continue to pull the indexer carriage 18 or 300 and the heater 24 longitudinally outward, the indexer carriage stripping rod 164 is automatically lifted as it rides up the ramp 165 on the indexer platform 20. This releases the indexer carriage stripping rod 164 from the stripping hook 166, and also releases the indexer carriage 18 or 300 and the heater 24.

On the other hand, if the heater 24 is adhered to the molten end of the movable pipe section, then the indexer carriage 18 or 300 and the heater 24 will be pulled outwardly by the fusion carriage 10 and the movable pipe until the indexer carriage 18 or 300 contacts the travel stop 168 on the indexer platform 20. This stops the outward longitudinal movement of the indexer carriage 18 or 300 so that, as the movable jaws 12 and 14 continue to move outward, the heater 24 is stripped from the molten end of the movable pipe.

But in either case, once the indexer carriage 18 or 300 has been released and is no longer moving outwardly with the movable jaws 12 and 14 and the movable pipe section, the heater latch mechanism is automatically triggered by the trigger mechanism 170 carried by the arm 174 of the stripping hook structure 166. The trigger mechanism 170 engages and rotates the heater release shaft 156, which in turn rotates the cam 162 on the shaft 156 to engage and pivot the heater release lever lifting arm 158, thereby tripping the heater latch release lever 150 to open the heater latch 33 or 362. Then, when the heater latch 33 or 362 is released, the gas springs or other biasing elements 72 and 74 of the heater linkage assembly 30 automatically pivot the heater 24 upward to its retracted position.

However, when the heater latch 33 or 362 is released and the upward movement of the heater 24 begins, the recessed portion 144 of the heater cam profile 58 rotates into contact with the heater cam follower 128. This engages the carriage brake assembly 38 to thereby prevent the indexer carriage 18 or 300 and the heater 24 from moving from side-to-side so that the heater 24 is not allowed to come into contact with the molten end of either pipe section as the heater 24 is rotated out of the fusion zone 15.

Once the heater 24 is clear of the fusion zone 15, as the heater 24 continues to pivot upwardly, the carriage brake assembly 38 (i) is momentarily released as the projecting tab 142 of the heater cam profile 58 rotates into contact with the heater cam follower 128 but then (ii) is re-engaged as the heater 24 continues to pivot upwardly to its fully retracted position and the radial recessed portion 140 of the heater cam profile 58 rotates into contact with the heater cam follower 128.

Finally, with the facer 22 and the heater 24 both removed from the fusion zone 15, the fusion carriage 10 and the movable jaws 12 and 14 move the molten end of the movable pipe section longitudinally into engagement with the molten end of the fixed section of pipe to fuse the pipe sections together.

FIG. 21 illustrates an alternative brake assembly 180 for the inventive fusion apparatus. The brake assembly 180 preferably uses the same facer and heater cam profiles as described above to push downwardly on the cam followers of the Tee-bar assembly to cause a lever arm to push downwardly on a linear bearing that rides on the indexer linear guide member to produce a friction lock between the indexer carriage and the indexer linear guide member.

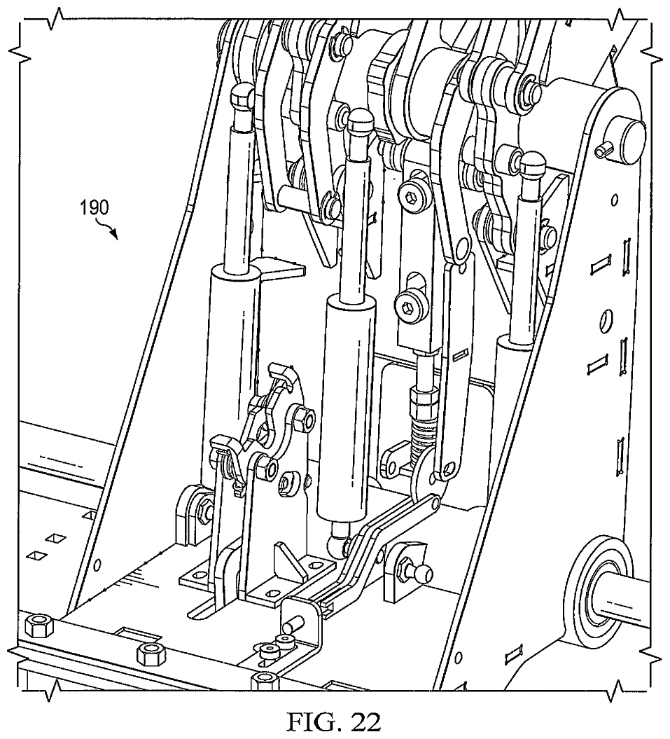

FIG. 22 illustrates another alternative brake assembly 190 for the inventive fusion apparatus. The brake assembly 190 preferably uses the same facer and heater cam profiles as described above to push downwardly on the Tee-bar assembly to activate a rocker cam which causes interlocking teeth to engage between the indexer carriage and the indexer platform to prevent horizontal motion.

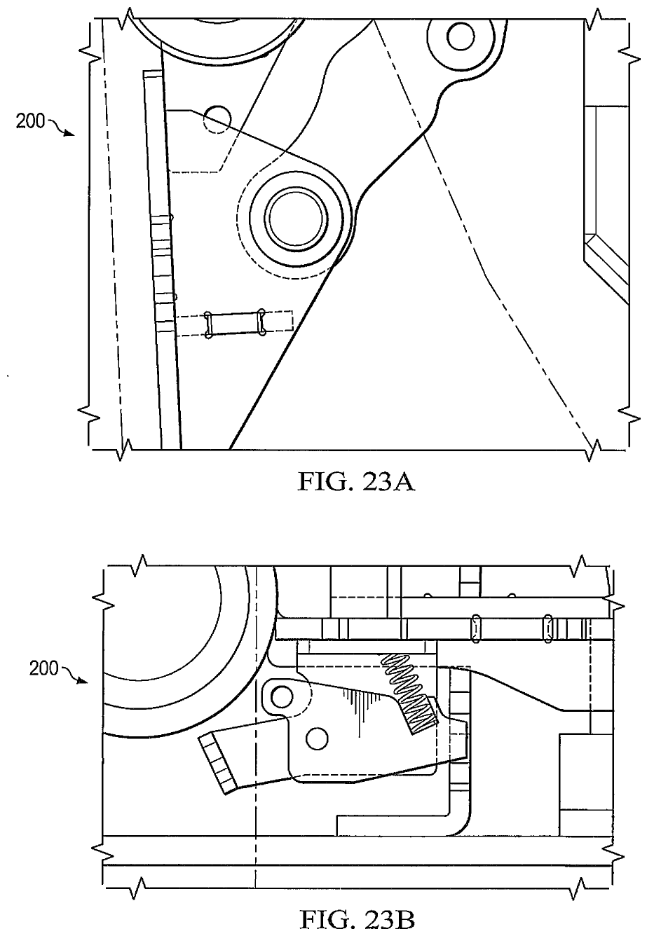

FIGS. 23A and 23B illustrate another alternative brake assembly 200 for the inventive fusion apparatus. In the brake assembly 200, the cam profiles push downwardly on a master hydraulic piston when either the heater or the facer are rotated inwardly so that a slave hydraulic cylinder disengages the brake assembly. The cams and brake assembly are the same as described above, but the Tee-bar assembly is replaced with a hydraulic block assembly that has two master cylinder inputs and one slave cylinder output.

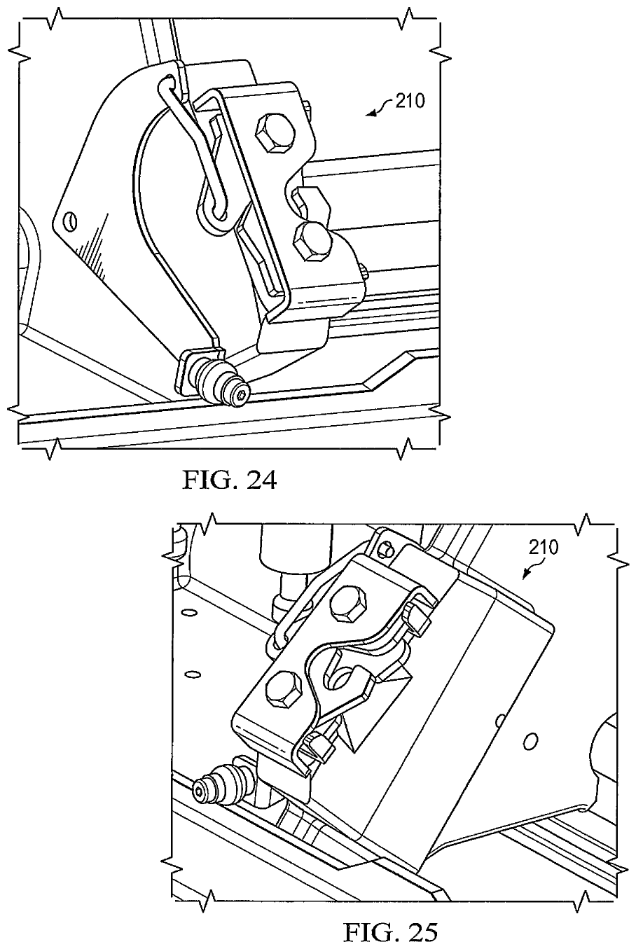

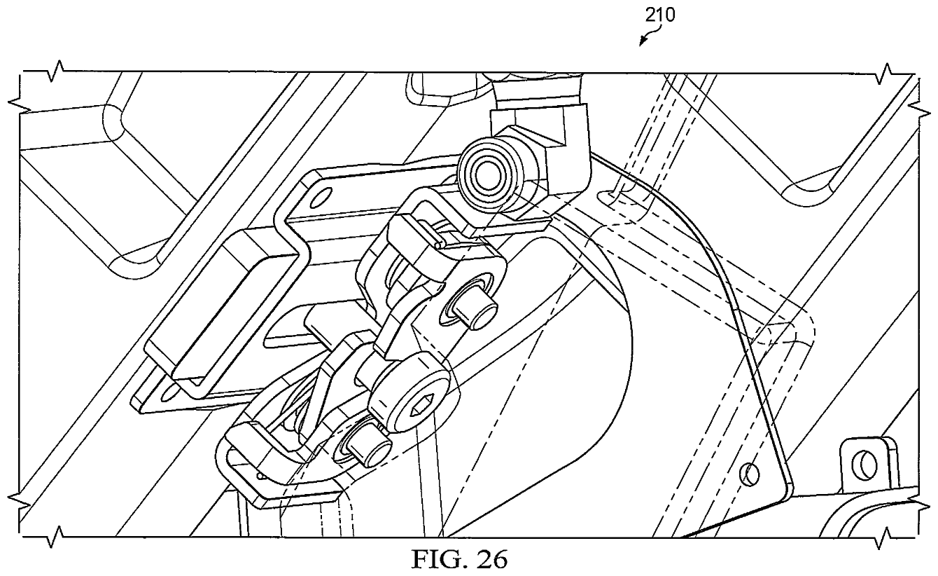

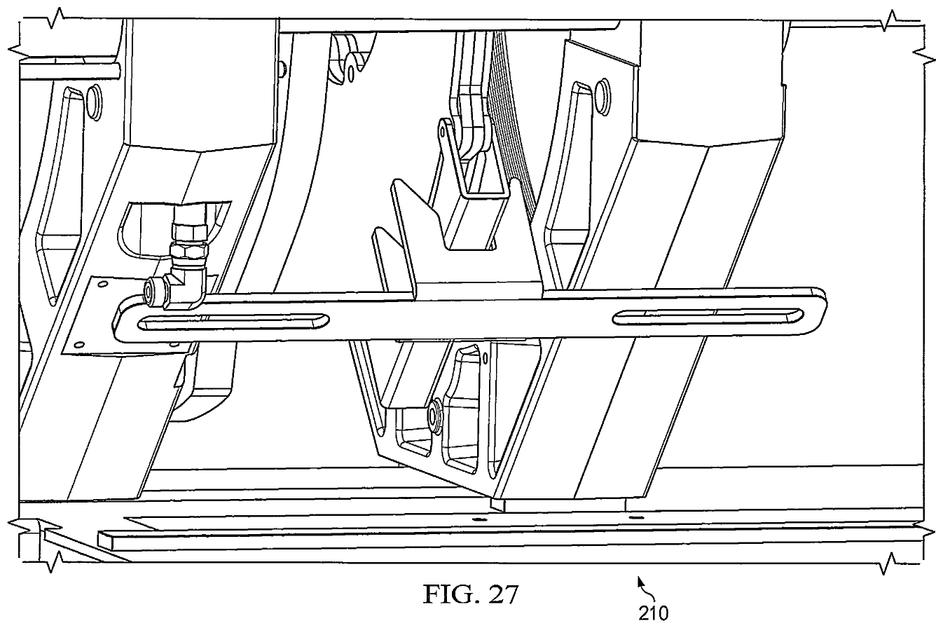

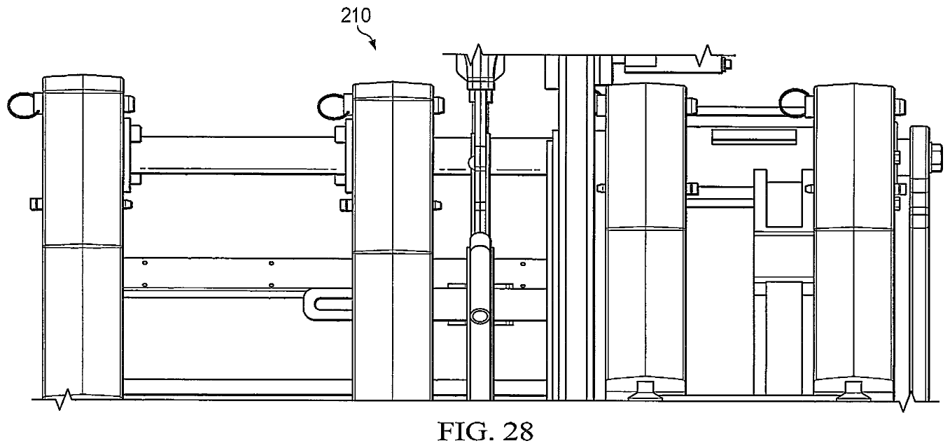

FIGS. 24-28 illustrate an alternative stripping mechanism 210 for the inventive fusion apparatus. The stripping mechanism 210 uses a push latch assembly that is connected to the moveable jaw 12 and will latch to a striker on the indexer carriage 18 or 300 to strip the heater from the pipe. The latch is released by a cam riding on at ramp profile to provide the timing of the latch release. FIGS. 27 and 28 show a stripping bar that has a U-shaped receptacle that the heater inserts in and is constrained to the inner moveable and inner fixed jaws by a pair of shoulder bolts riding in slots on the stripper bar. As the fusion carriage opens, the shoulder bolts ride in the slots and force the heater to center and strip from both sides of the pipe. The slots are adjusted in length to ensure the heater strips before the heater is released.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within the invention.

What is claimed is:

1. An apparatus for pipe fusion comprising;
a fixed pipe jaw;
a movable pipe jaw which is longitudinally movable toward the fixed pipe jaw and away from the fixed pipe jaw;
a fusion zone between the fixed pipe jaw and movable pipe jaw;
an indexer carriage which is longitudinally movable;
a heater held by a heater linkage assembly which is carried by the indexer carriage, the heater being downwardly pivotable to an operating position in the fusion zone and upwardly pivotable to a fully retracted position outside of the fusion zone; and
the heater linkage assembly being biased by one or more biasing elements to continuously urge the heater upwardly toward the fully retracted position of the heater.

2. The apparatus of claim 1 further comprising:
a carriage braking assembly carried by the indexer carriage,
the carriage braking assembly being automatically engaged, to prevent the indexer carriage and the heater from moving longitudinally, when the heater is entering and when the heater is exiting the fusion zone, and
the carriage braking assembly being automatically disengaged, to permit the indexer carriage and the heater to move longitudinally, when the heater is in the operating position of the heater in the fusion zone.

3. The apparatus of claim 2 further comprising:
a fixed linear guide member which extends longitudinally through the indexer carriage for movement of the indexer carriage along the fixed linear guide member and
the carriage braking assembly having a brake element which (i) is in contact with the fixed linear guide member when the heater is entering and when the heater is exiting the fusion zone to prevent the indexer carriage and the heater from moving longitudinally and (ii) is not in contact with the fixed linear guide member when the heater is in the operating position of the heater in the fusion zone, which permits the indexer carriage and the heater to move longitudinally.

4. The apparatus of claim 2 further comprising:
the heater linkage assembly including a heater cam profile which rotates with the heater as the heater is pivoted downwardly to the operating position of the heater in the fusion zone and upwardly to the fully retracted position of the heater;
the carriage braking assembly including a heater cam follower which contacts and follows the heater cam profile;
the heater cam profile having at least one radially projecting portion and at least one radially recessed portion; and
the at least one radially projecting and the at least one radially recessed portions of the heater cam profile of the heater linkage assembly acting on the heater cam follower of the carriage braking assembly to (i) automatically engage the carriage braking assembly when the heater is entering and when the heater is exiting the fusion zone and (ii) automatically disengage the carriage braking assembly when the heater is in the operating position of the heater in the fusion zone.

5. The apparatus of claim 4 further comprising:
a facer held by a facer linkage assembly which is carried by the indexer carriage, the facer being downwardly pivotable to an operating position in the fusion zone and upwardly pivotable to a fully retracted position outside of the fusion zone;
the facer linkage assembly including a facer cam profile which rotates with the facer as the facer is pivoted downwardly to the operating position of the facer in the fusion zone and upwardly to the fully retracted position of the facer;
the carriage braking assembly including a facer cam follower which contacts and follows the facer cam profile;
the facer cam profile having at least one radially projecting portion and at least one radially recessed portion; and
the at least one radially projecting and the at least one radially recessed portions of the facer cam profile of the heater linkage assembly acting on the facer cam follower of the carriage braking assembly to (i) automatically engage the carriage braking assembly, to prevent the indexer carriage and the facer from moving longitudinally, when the facer is entering and when the facer is exiting the fusion zone and (ii) automatically disengage the carriage braking assembly, to permit the indexer carriage and the facer to move longitudinally, when the facer is in the operating position of the facer in the fusion zone.

6. The apparatus of claim 1 further comprising a heater stripping system for detaching the heater when, after a heating operation, the heater is stuck to a molten end of a first pipe held by the fixed pipe jaw or the heater is stuck to a molten end of a second pipe held by the movable pipe jaw, the heater stripping system comprising:
a stripping rod, held by the indexer carriage, which can be pivoted or lifted upwardly;
a stripping hook which moves longitudinally with the movable pipe jaw and which catches the stripping rod, when the heater is stuck to the molten end of the first pipe held by the fixed pipe jaw, as the movable pipe jaw moves away from the fixed pipe jaw;
a lifting structure, over which the stripping rod travels as the stripping hook pulls the stripping rod and the indexer carriage, the lifting structure causing the stripping rod to pivot or move upwardly to release the stripping rod from the stripping hook; and
a fixed travel stop which, if the indexer carriage is stuck the molten end of the second pipe held by the movable pipe jaw, is contacted by the indexer carriage and stops the indexer carriage from continuing to travel with the movable pipe jaw.

7. The apparatus of claim 6 further comprising the lifting structure being a ramp.

8. The apparatus of claim 6 further comprising:
the lifting structure being a first lifting structure and
the apparatus also comprising a second lifting structure over which the stripping rod will travel when the indexer carriage is moved from the fusion zone toward the fixed pipe jaw to allow the fixed pipe jaw and the movable pipe jaw to be opened after a fusion operation, the second lifting structure causing the stripping rod to pivot or move upwardly so that the stripping rod moves over and clears the stripping hook as the indexer carriage is moved toward the fixed pipe jaw.

9. The apparatus of claim 6 further comprising:
a heater latch provided in the indexer carriage which receives a latch element of the heater linkage assembly when the heater is pivoted downwardly to the operating position of the heater in the fusion zone;
a latch release assembly; and
a trigger mechanism which moves with the movable pipe jaw and triggers the latch release assembly, after the indexer carriage contacts the fixed travel stop, to automatically cause the heater latch to release the latch element of the heater linkage assembly.

10. The apparatus of claim 9 further comprising the trigger mechanism comprising an upwardly projecting tab on an arm of the stripping hook.

11. The apparatus of claim 9 further comprising the heater latch being an elbow latch.

12. The apparatus of claim 1 further comprising a heater retention mechanism which does not interfere when pivoting the heater downwardly from the fully retracted position of the heater to the operating position of the heater in the fusion zone, but will retain the heater when lowered to at least one intermediate position between the fully retracted position and the operating position to prevent the heater from automatically returning to the fully retracted position of the heater, the heater retention mechanism comprising:
a ratchet pawl which is pivotably carried by the indexer carriage;
a retention ring which is included in the heater linkage assembly and rotates with the heater as the heater is pivoted downwardly to the operating position of the heater in the fusion zone and upwardly to the fully retracted position of the heater; and
at least one retention structure on the retention ring which will not engage the ratchet pawl when pivoting the heater downwardly from the fully retracted position of the heater to the operating position of the heater in the fusion zone but will engage the ratchet pawl if the heater is released when being pivoted downwardly from the fully retracted position toward the operating position in the fusion zone to prevent the heater from automatically returning to the fully retracted position of the heater.

13. The apparatus of claim 12 further comprising:
the heater retention mechanism also comprising a toggle and
the toggle automatically engages the ratchet pawl when or as the heater is received in the operating position of the heater in the fusion zone to disengage the heater retention mechanism so that the heater retention mechanism does not retain the heater when the heater subsequently automatically returns, after a heating operation is completed, from the operating position of the heater in the fusion zone to the fully retracted position of the heater.

14. The apparatus of claim 13 further comprising the toggle of the heater retention mechanism automatically releasing the ratchet pawl as or when the heater returns upwardly to the fully retracted position of the heater to reset the heater retention mechanism for re-engagement of the ratchet pawl with the retention ring when the heater is subsequently pivoted downwardly again from the fully retracted position of the heater toward the operating position of the heater in the fusion zone.

15. A method of fusing an end of a first pipe segment and an end of a second pipe segment together using a pipe fusion apparatus, the first pipe segment being held by one or more fixed pipe jaws of the pipe fusion apparatus and the second pipe segment being held by one or more movable pipe jaws of the pipe fusion apparatus, the moveable pipe jaws being longitudinally movable toward and away from the fixed pipe jaws, and the method comprising:
a step (a) of pivoting a heater downwardly to an operating position of the heater in a fusion zone between the end of the first pipe segment and the end of the second pipe segment, the heater being held by and pivoted using a heater linkage assembly which is carried by an indexer carriage;
the indexer carriage also including a carriage brake;
the carriage brake being automatically engaged, to prevent the indexer carriage and the heater from moving longitudinally, when the heater is entering the fusion zone; and
the carriage brake being automatically disengaged, to permit the indexer carriage and the heater to move longitudinally, when the heater is in the operating position of the heater in the fusion zone.

16. The method of claim 15 further comprising:
a step, prior to the step (a), of pivoting a facer downwardly to an operating position of the facer in the fusion zone, the facer being held by and pivoted using a facer linkage assembly which is carried by the indexer carriage;
the carriage brake being automatically engaged, to prevent the indexer carriage and the facer from moving longitudinally, when the facer is entering the fusion zone; and
the carriage brake being automatically disengaged, to permit the indexer carriage and the facer to move longitudinally, when the facer is in the operating position of the facer in the fusion zone.

17. The method of claim 15 further comprising:
a step (b), following the step (a), of operating the heater in the fusion zone to simultaneously heat the end of the first pipe segment and the end of the second pipe segment and
a step (c), following the step (b), of stripping the heater from the end of the first pipe segment and/or the end of the second pipe segment by
moving the one or more movable pipe jaws longitudinally away from the one or more fixed pipe jaws,
as the one or more movable pipe jaws continue to move away from the one or more fixed pipe jaws, if the heater is stuck to the end of the first pipe segment or if the heater is not stuck to either the end of the first pipe segment or the end of the second pipe segment, catching a stripping rod of the indexer carriage with a stripping hook which travels with the one or more movable pipe jaws to pull the indexer carriage and the heater away from the one or more fixed pipe jaws as the one or more movable pipe jaws continue to move away from the one or more fixed pipe jaws,
pulling the stripping rod over a lift structure which pivots or moves the stripping rod upwardly to release the stripping rod from the stripping hook, and
as the one or more movable pipe jaws continue to move away from the one or more fixed pipe jaws, if the heater is stuck to the end of the second pipe segment, pulling the indexer carriage into contact with a fixed travel stop which stops the indexer carriage and the heater from continuing to move away from the one or more fixed pipe jaws with the one or more movable pipe jaws.

18. The method of claim 17 further comprising:
the heater linkage assembly being biased by one or more biasing elements which continuously urge the heater upwardly toward a fully retracted position of the heater;
the heater being retained in the fusion zone in the step (b) by a heater latch which is provided in the indexer carriage; and
the heater latch being automatically released after step (c) so that the one or more biasing elements automatically move the heater upwardly to the fully retracted position of the heater.

19. The method of claim 18 further comprising, after the heater latch is automatically released, the carriage brake being automatically engaged, to prevent the indexer carriage and the heater from moving longitudinally, as the one or more biasing elements are automatically moving the heater upwardly out of the fusion zone.

20. The method of claim 15 further comprising:
the heater linkage assembly being biased by one or more biasing elements which continuously urge the heater upwardly toward a fully retracted position of the heater;
the heater being pivoted downwardly in the step (a) from the fully retracted position of the heater to the operating position of the heater in the fusion zone;
during step (a), the heater is released at an intermediate location between the fully retracted position and the operating position of the heater in the fusion zone;
when the heater is released at the intermediate location, a heater retention mechanism automatically prevents the heater from being returned by the one or more biasing elements to the fully retracted position; and
the heater retention mechanism does not interfere with the downward movement from the fully retracted position to the operating position of the heater in the fusion zone.

21. The method of claim 20 further comprising the heater retention mechanism being automatically disengaged when or as the heater is received in the operating position of the heater in the fusion zone so that the heater retention mechanism will not prevent the one or more biassing elements from returning the heater from the operating position in the fusion zone to the fully retracted position of the heater.

22. The method of claim 21 further comprising the heater retention mechanism being automatically re-engaged when or as the heater returns to the fully retracted position of the heater.
